(19) United States
(12) Patent Application Publication
(10) Pub. No.: US 2026/0259449 A1
(43) Pub. Date: Sep. 3, 2026

(54) DISPLAY DEVICE AND METHOD OF MANUFACTURING THE SAME

(71) Applicants: BEIJING BOE DISPLAY TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(72) Inventors: Tingxiu Hou, Beijing (CN); Xiuyun Chen, Beijing (CN); Peng Zhong, Beijing (CN); Jingjun Du, Beijing (CN); Yaxin Sun, Beijing (CN); Qianqian Hao, Beijing (CN); Ziyan Zhang, Beijing (CN); Weibo Li, Beijing (CN); Cunqing Guo, Beijing (CN); Yichi Zhang, Beijing (CN)

(21) Appl. No.: 18/995,815

(22) PCT Filed: May 14, 2024
(86) PCT No.: PCT/CN2024/093199

§ 371 Date: Jan. 16, 2025

(30) Foreign Application Priority Data
Jun. 21, 2023 (CN) 202310749147.X

(51) Int. Cl. G02F 1/1335; F21V 8/00; G02F 1/1333; G02F 1/13357; G02F 1/1343

(52) U.S. Cl. CPC G02F 1/133553; G02B 6/0038; G02B 6/0046; G02F 1/13338; G02F 1/133512; G02F 1/133524; G02F 1/133603; G02F 1/134336

(57) ABSTRACT

A display device is provided, including: a base substrate; a reflective assembly including an upper surface with protruding portions, and a side tangent of the protruding portion has a first angle with the upper surface; a display assembly including a liquid crystal layer having a first refractive index; and a light emitting assembly including: a light guide plate having a second refractive index, where the light guide plate includes an upper surface and a peripheral surface, the light guide plate upper end surface is provided with first recessed portions recessed in a direction towards the base substrate, and an inclined side surface of the first recessed portion has a second angle with the upper surface of the light guide plate; and a light source configured to emit a light ray towards the peripheral surface, and the light ray has a third angle with peripheral surface.

### CROSS-REFERENCE TO RELATED APPLICATION(S)

This application is a Section 371 National Stage Application of International Application No. PCT/CN2024/093199, filed on May 14, 2024, entitled “DISPLAY DEVICE AND METHOD OF MANUFACTURING THE SAME”, which claims priority to Chinese Application No. 202310749147.X, filed on Jun. 21, 2023, the contents of which are incorporated herein by reference in their entireties.

### TECHNICAL FIELD

The present disclosure relates to a field of display technology, and in particular to a display device and a method of manufacturing the same.

### BACKGROUND

Reflective-type LCD (RLCD) may achieve display by reflecting ambient light through a metal layer of a TFT substrate, which eliminates the need for a backlight and has advantages of low power consumption and lightweight. However, when the ambient light is weak, it is required to provide a front light source for auxiliary display, and the front light source for auxiliary display may easily result in problems such as low contrast, poor image quality contrast, yellowing of a display panel caused by long-term outdoor use, and poor uniformity caused by the front light source, which may reduce a display effect.

The above information disclosed in this section is merely for the understanding of the background of technical concepts of the present disclosure. Therefore, the above information may contain information that does not constitute a related art.

### SUMMARY

In an aspect, a display device is provided, including: a base substrate; a reflective assembly on a side of the base substrate, where the reflective assembly includes a reflective assembly upper end surface away from the base substrate, the reflective assembly upper end surface is provided with a plurality of protruding portions, a side tangent of the protruding portion has a first angle θ1 with the reflective assembly upper end surface, and the side tangent is a tangent of a side edge between a lowest point and a highest point of the protruding portion at a midpoint position; a display assembly on a side of the reflective assembly away from the base substrate, where the display assembly includes a liquid crystal layer having a first refractive index n₁; and a light emitting assembly on a side of the display assembly away from the base substrate, where the light emitting assembly includes: a light guide plate having a second refractive index n₂, where the light guide plate includes a light guide plate upper end surface away from the base substrate and a light guide plate peripheral side surface, the light guide plate upper end surface is provided with a plurality of first recessed portions recessed in a direction towards the base substrate, and an inclined side surface of the first recessed portion facing the light guide plate peripheral side surface has a second angle θ₂ with the light guide plate upper end surface; and a light source opposite to the light guide plate peripheral side surface, where the light source is configured to emit a light ray towards the light guide plate peripheral side surface, and the light ray has a third angle θ₃ with the light guide plate peripheral side surface, where the second angle θ₂ meets a relationship of:

$${Θ}_{2} = 90 ° - \frac{1}{2} [ arccos ( \frac{1}{{n}_{2}} \times sin {θ}_{3} ) + arcsin ( \frac{{n}_{1}}{{n}_{2}} \times sin 2 {Θ}_{1} ) ] .$$

In some exemplary embodiments of the present disclosure, the light guide plate upper end surface of the light guide plate includes: a first region, where an orthographic projection of the first region on the base substrate overlaps partially with an orthographic projection of the liquid crystal layer of the display assembly on the base substrate, and the first recessed portions are arranged in the first region; and a second region between the first region and the light guide plate peripheral side surface.

In some exemplary embodiments of the present disclosure, a distribution density ρ of the first recessed portions in the first region gradually increases in a direction from a position close to the light guide plate peripheral side surface to a position away from the light guide plate peripheral side surface.

In some exemplary embodiments of the present disclosure, the distribution density ρ of the first recessed portions in the first region meets a relationship of:

$$ρ = \frac{N \times {S}_{1}}{{S}_{2}}$$

where S₁ represents an opening area of the first recessed portion, S₂ represents a unit area, N represents the number of first recessed portions in the unit area S₂, and 4%≤p≤10%.

In some exemplary embodiments of the present disclosure, an orthographic projection of the light guide plate on the base substrate is a circle; and the first recessed portion includes a conical recessed portion or a circular frustum-shaped recessed portion, and a generatrix of the conical recessed portion or the circular frustum-shaped recessed portion has the second angle θ₂ with the light guide plate upper end surface.

In some exemplary embodiments of the present disclosure, the orthographic projection of the light guide plate on the base substrate is an n-sided polygon, and n is an integer greater than or equal to 5; and the first recessed portion includes: a conical recessed portion or a circular frustum-shaped recessed portion, where a generatrix of the conical recessed portion or the circular frustum-shaped recessed portion has the second angle θ₂ with the light guide plate upper end surface; and/or an n-sided pyramid-shaped recessed portion or an n-sided frustum-shaped recessed portion, where an inclined side surface of the n-sided pyramid-shaped recessed portion or the n-sided frustum-shaped recessed portion facing the light guide plate peripheral side surface has the second angle θ₂ with the light guide plate upper end surface.

In some exemplary embodiments of the present disclosure, the orthographic projection of the light guide plate on the base substrate is a quadrilateral; the light guide plate peripheral side surface includes a first peripheral side surface and a second peripheral side surface opposite to each other and a third peripheral side surface and a fourth peripheral side surface opposite to each other, and the third peripheral side surface and the fourth peripheral side surface each are connected and perpendicular to the first peripheral side surface and the second peripheral side surface; and the light source is opposite to the first peripheral side surface and the second peripheral side surface respectively.

In some exemplary embodiments of the present disclosure, the first recessed portion includes a quadrangular pyramid-shaped recessed portion, and the quadrangular pyramid-shaped recessed portion includes: a first inclined side surface facing the first peripheral side surface; a second inclined side surface opposite to the first inclined side surface and facing the second peripheral side surface; a third inclined side surface between the first inclined side surface and the second inclined side surface, where the third inclined side surface faces the third peripheral side surface; and a fourth inclined side surface opposite to the third inclined side surface and facing the fourth peripheral side surface, where the first inclined side surface and the second inclined side surface respectively form the second angle θ₂ with the light guide plate upper end surface.

In some exemplary embodiments of the present disclosure, the third inclined side surface and the fourth inclined side surface respectively form a fourth angle θ₄ with the light guide plate upper end surface, the second angle θ₂ is less than the fourth angle θ₄, and the fourth angle θ₄ is less than or equal to 80°.

In some exemplary embodiments of the present disclosure, a connecting chamfer R is formed between inclined side surfaces of the quadrangular pyramid-shaped recessed portion, and the connecting chamfer R is less than or equal to 1.5 μm.

In some exemplary embodiments of the present disclosure, the quadrangular pyramid-shaped recessed portion has a depth h1 recessed in a direction towards the base substrate, and 3 μm≤h1≤8 μm.

In some exemplary embodiments of the present disclosure, a plurality of second recessed portions recessed in the direction towards the base substrate are uniformly provided in the second region of the light guide plate upper end surface, and the second recessed portion includes a spherical crown-shaped recessed portion.

In some exemplary embodiments of the present disclosure, the spherical crown-shaped recessed portion has a depth h2 recessed in the direction towards the base substrate, 1 μm≤h2≤9 μm; the spherical crown-shaped recessed portion has a cross-sectional diameter D, 18 μm≤D≤50 μm; and a distribution density value of the spherical crown-shaped recessed portions in the second region is less than or equal to 2%.

In some exemplary embodiments of the present disclosure, the liquid crystal layer of the display assembly includes a plurality of pixel units arranged in an array in a first direction and a second direction intersecting with the first direction, each pixel unit includes a plurality of sub-pixels arranged sequentially in the first direction, and each sub-pixel has a length direction extending in the second direction and a width direction parallel to the first direction.

In some exemplary embodiments of the present disclosure, the light guide plate includes a light guide plate lower end surface close to the base substrate, the light guide plate lower end surface is provided with third recessed portions recessed in a direction away from the base substrate, and the third recessed portions include V-shaped groove recessed portions extending in the first direction and spaced apart in the second direction.

In some exemplary embodiments of the present disclosure, the V-shaped groove recessed portion has a depth h3 in a direction away from the base substrate, 1 μm≤h3≤30 μm; and the V-shaped groove recessed portion has an opening width W in the second direction, 5 μm≤W≤30 μm.

In some exemplary embodiments of the present disclosure, the opening width of the V-shaped groove recessed portion is less than or equal to half of a width of the sub-pixel; and at least one V-shaped groove recessed portion extending in the first direction is provided in the length direction of each sub-pixel.

In some exemplary embodiments of the present disclosure, the light source includes a single-row light source formed by a plurality of illuminators spaced apart along the light guide plate peripheral side surface, a spacing G is formed between adjacent illuminators of the single-row light source, and the spacing G meets a relationship of:

$$G = 2 \times A \times tan {θ}_{4}$$

where A represents a width from the light guide plate peripheral side surface to the first region, and θ₄ represents a refractive angle of a light beam of the illuminator formed after the light beam enters the light guide plate.

In some exemplary embodiments of the present disclosure, the light source includes a multi-row light source formed by a plurality of single-row light sources staggered along the light guide plate peripheral side surface, the single-row light source is formed by a plurality of illuminators spaced apart along the light guide plate peripheral side surface, a spacing G is formed between adjacent illuminators of the single-row light source, and 0.35 mm≤G≤0.9 mm.

In some exemplary embodiments of the present disclosure, the display device further includes: a touch assembly on a side of the light emitting assembly away from the base substrate; and a light shielding assembly between the touch assembly and the light emitting assembly, where an orthographic projection of the light shielding assembly on the base substrate falls within an orthographic projection of the second region on the base substrate.

In some exemplary embodiments of the present disclosure, the light shielding assembly includes: a shielding plate parallel to the light guide plate upper end surface; and a bending portion connected to the shielding plate, where the bending portion is bent from the shielding plate towards the light guide plate upper end surface in a direction away from the light guide plate peripheral side surface.

In some exemplary embodiments of the present disclosure, the light shielding assembly includes: a shielding plate parallel to the light guide plate upper end surface; and a shielding sub-plate between the shielding plate and the light guide plate, where an orthographic projection of the shielding sub-plate on the base substrate falls within an orthographic projection of the shielding plate on the base substrate, and the shielding sub-plate is close to the first region.

In some exemplary embodiments of the present disclosure, the display device further includes: a bonding layer between the touch assembly and the light shielding assembly and between the light shielding assembly and the light emitting assembly, where an orthographic projection of the bonding layer on the base substrate falls within an orthographic projection of the second region on the base substrate.

In some exemplary embodiments of the present disclosure, the light guide plate is made of glass.

In some exemplary embodiments of the present disclosure, an angle θ₅ between an incident light ray of the light source and the light guide plate peripheral side surface is in a range of 0°≤θ₅≤60°.

In some exemplary embodiments of the present disclosure, the display device further includes: a touch assembly on a side of the light emitting assembly away from the base substrate; and a bonding layer between the touch assembly and the light emitting assembly, where the bonding layer is configured to bond the touch assembly with the light emitting assembly, and an orthographic projection of the bonding layer on the base substrate coincides with the orthographic projection of the liquid crystal layer of the display assembly on the base substrate.

In some exemplary embodiments of the present disclosure, the first angle θ₁ is in a range of 5°≤θ₁≤15°, and the second angle θ₂ is in a range of 35°≤θ₂≤50°.

In another aspect of the present disclosure, a method of manufacturing a display device is provided, including: providing a base substrate; forming a reflective assembly on a side of the base substrate, where the reflective assembly includes a reflective assembly upper end surface away from the base substrate, the reflective assembly upper end surface is provided with a plurality of protruding portions, a side tangent of the protruding portion has a first angle θ₁ with the reflective assembly upper end surface, and the side tangent is a tangent of a side edge between a lowest point and a highest point of the protruding portion at a midpoint position; forming a display assembly on a side of the reflective assembly away from the base substrate, where the display assembly includes a liquid crystal layer having a first refractive index n₁; forming a light emitting assembly on a side of the display assembly away from the base substrate, where the forming a light emitting assembly includes: forming a light guide plate having a second refractive index n₂, where the light guide plate includes a light guide plate upper end surface away from the base substrate and a light guide plate peripheral side surface, the light guide plate upper end surface is provided with a plurality of first recessed portions recessed in a direction towards the base substrate, and an inclined side surface of the first recessed portion facing the light guide plate peripheral side surface has a second angle θ₂ with the light guide plate upper end surface; and forming a light source at a position opposite to the light guide plate peripheral side surface, where the light source is configured to emit a light ray towards the light guide plate peripheral side surface, and the light ray has a third angle θ₃ with the light guide plate peripheral side surface, where the second angle θ₂ meets a relationship of:

$${Θ}_{2} = 90 ° - \frac{1}{2} [ arccos ( \frac{1}{{n}_{2}} \times sin {θ}_{3} ) + arcsin ( \frac{{n}_{1}}{{n}_{2}} \times sin 2 {Θ}_{1} ) ] .$$

In some exemplary embodiments of the present disclosure, a first ion beam includes an inclined ion beam in a first direction and an inclined ion beam in a second direction, the first recessed portion has a symmetry axis, and an inclined surface of the first recessed portion includes a first inclined surface and a second inclined surface that are mirror symmetric with respect to the symmetry axis, and the forming the first recessed portion in the first region through a first ion beam etching process includes: etching to form the first inclined surface of the first recessed portion through the inclined ion beam in the first direction, and etching to form the second inclined surface of the first recessed portion through the inclined ion beam in the second direction, where the first direction and the second direction are mirror symmetric with respect to the symmetry axis, the first direction has a first angle θ21 with the light guide plate upper end surface, the second direction has a second angle θ₂₂ with the light guide plate upper end surface, and θ₂₁=θ₂₂=θ₂.

In some exemplary embodiments of the present disclosure, the second ion beam includes an inclined ion beam in a third direction and an inclined ion beam in a fourth direction, the third recessed portion has a symmetry plane, the third recessed portion includes a first inclined surface and a second inclined surface that are mirror symmetric with respect to the symmetry plane, and the forming a third recessed portion on the light guide plate lower end surface through a second ion beam etching process includes: etching to form the first inclined surface of the third recessed portion through the inclined ion beam in the third direction, and etching to form the second inclined surface of the third recessed portion through the inclined ion beam in the fourth direction, where the third direction and the fourth direction are mirror symmetric with respect to the symmetry plane.

### BRIEF DESCRIPTION OF THE DRAWINGS

By describing in detail exemplary embodiments of the present disclosure with reference to the accompanying drawings, features and advantages of the present disclosure will become more apparent.

FIG. 1A shows a schematic diagram of a planar structure of a display substrate according to an exemplary embodiment of the present disclosure;

FIG. 1B shows a schematic diagram of a cross-sectional structure of the display substrate according to an exemplary embodiment of the present disclosure, taken along section line B-B in FIG. 1A;

FIG. 1C shows a schematic diagram of a cross-sectional structure of the display substrate according to another exemplary embodiment of the present disclosure, taken along section line B-B in FIG. 1A;

FIG. 2A shows a schematic diagram of a cross-sectional structure of a reflective assembly according to an exemplary embodiment of the present disclosure;

FIG. 2B shows a schematic diagram of an optical path entering a liquid crystal layer by the reflective assembly according to an exemplary embodiment of the present disclosure;

FIG. 2C shows a schematic diagram of a surface morphology of the reflective assembly according to an exemplary embodiment of the present disclosure;

FIG. 3A shows a schematic diagram of a cross-sectional structure of a light emitting assembly according to an exemplary embodiment of the present disclosure;

FIG. 3B shows a schematic diagram of an optical path after a light source of the light emitting assembly enters a light guide plate according to an exemplary embodiment of the present disclosure;

FIG. 3C shows a schematic diagram of a planar structure of the light emitting assembly according to an exemplary embodiment of the present disclosure;

FIG. 3D shows a schematic diagram of a three-dimensional structure of the light emitting assembly from a viewing angle according to an exemplary embodiment of the present disclosure;

FIG. 3E shows a schematic diagram of a three-dimensional structure of the light emitting assembly from another viewing angle according to an exemplary embodiment of the present disclosure;

FIG. 4A shows a schematic structural diagram of a first recessed portion on the light emitting assembly according to an exemplary embodiment of the present disclosure;

FIG. 4B shows a schematic structural diagram of the first recessed portion on the light emitting assembly according to another exemplary embodiment of the present disclosure;

FIG. 4C shows a relationship curve between a second angle and a light output brightness of a light guide plate lower end surface according to an exemplary embodiment of the present disclosure;

FIG. 4D shows a relationship curve between the second angle and a peak light output angle at the light guide plate lower end surface according to an exemplary embodiment of the present disclosure;

FIG. 4E shows a relationship curve between a depth of the first recessed portion and the light output brightness of the light guide plate lower end surface according to an exemplary embodiment of the present disclosure;

FIG. 4F shows a distribution density curve of the first recessed portions on the light guide plate according to an exemplary embodiment of the present disclosure;

FIG. 4G shows a schematic structural diagram of the first recessed portion on the light emitting assembly according to an exemplary embodiment of the present disclosure;

FIG. 4H shows a schematic structural diagram of the first recessed portion on the light emitting assembly according to another exemplary embodiment of the present disclosure;

FIG. 5A shows a schematic structural diagram of a second recessed portion on the light emitting assembly according to an exemplary embodiment of the present disclosure;

FIG. 5B shows a schematic diagram of a light source of the light emitting assembly generating a strip-shaped light beam in an exemplary embodiment;

FIG. 5C shows a schematic diagram of light rays from a light source being transmitted in the second recessed portion according to an exemplary embodiment of the present disclosure;

FIG. 5D shows a schematic diagram of a cross-sectional structure of the second recessed portion on the light emitting assembly according to an exemplary embodiment of the present disclosure;

FIG. 5E shows a variation curve of a depth h2 of the second recessed portion and a luminous flux loss according to an exemplary embodiment of the present disclosure;

FIG. 5F shows a variation curve of a distribution density of the second recessed portions and a luminous flux loss according to an exemplary embodiment of the present disclosure;

FIG. 6A shows a light transmission diagram in a case of no third recessed portion is provided on the light emitting assembly;

FIG. 6B shows a schematic diagram of light rays being transmitted on the third recessed portion of the light emitting assembly according to an exemplary embodiment of the present disclosure;

FIG. 6C shows a schematic diagram of light rays being transmitted on the third recessed portion of the light emitting assembly according to another exemplary embodiment of the present disclosure;

FIG. 6D shows a schematic diagram of an arrangement relationship between the third recessed portions and pixel units on the light emitting assembly according to an exemplary embodiment of the present disclosure;

FIG. 6E shows a relationship curve between a spacing of the third recessed portions and a peak light output brightness at the light guide plate lower end surface according to an exemplary embodiment of the present disclosure;

FIG. 6F shows a relationship curve between a depth h3 of the third recessed portion and the peak light output brightness at the light guide plate lower end surface according to an exemplary embodiment of the present disclosure;

FIG. 7A shows a schematic structural diagram of a light source of the light emitting assembly according to an exemplary embodiment of the present disclosure;

FIG. 7B shows a schematic structural diagram of a light source of the light emitting assembly according to another exemplary embodiment of the present disclosure;

FIG. 8A shows a schematic structural diagram of a light shielding assembly of a display device according to an exemplary embodiment of the present disclosure;

FIG. 8B shows a schematic structural diagram of a light shielding assembly of the display device according to another exemplary embodiment of the present disclosure;

FIG. 9 shows a schematic diagram of a planar structure of a display device according to an exemplary embodiment of the present disclosure;

FIG. 10 shows a schematic diagram of a planar structure of a display device according to an exemplary embodiment of the present disclosure;

FIG. 11 shows a flowchart of a method of manufacturing a display device according to an exemplary embodiment of the present disclosure; and

FIG. 12A to FIG. 12D show schematic diagrams of a manufacturing process of the first recessed portion of the display device according to an exemplary embodiment of the present disclosure.

### DETAILED DESCRIPTION OF EMBODIMENTS

In order to make objectives, technical solutions and advantages of the embodiments of the present disclosure clearer, the technical solutions of the embodiments of the present disclosure will be clearly and completely described below with reference to the accompanying drawings. Obviously, the described embodiments are merely some embodiments rather than all embodiments of the present disclosure. Based on the described embodiments of the present disclosure, all additional embodiments obtained by those ordinary skilled in the art without carrying out inventive effort fall within the scope of protection of the present disclosure.

It should be noted that in the accompanying drawings, for clarity and/or description purposes, a size and relative size of an element may be enlarged. Accordingly, the size and relative size of each element need not to be limited to those shown in the figures. In the specification and the accompanying drawings, the same or similar reference numerals represent the same or similar components.

When an element is described as being “on”, “connected to” or “coupled to” another element, the element may be directly on the another element, directly connected to the another element, or directly coupled to the another element, or an intermediate element may be provided. However, when an element is described as being “directly on”, “directly connected to” or “directly coupled to” another element, no intermediate element is provided. Other terms and/or expressions used to describe a relationship between elements, such as “between” and “directly between”, “adjacent to” and “directly adjacent to”, “on” and “directly on”, and so on, should be interpreted in a similar manner. Moreover, the term “connection” may refer to a physical connection, an electrical connection, a communicative connection, and/or a fluid connection. In addition, X-axis, Y-axis and Z-axis are not limited to three axes of a rectangular coordinate system, and may be interpreted in a broader meaning. For example, the X-axis, the Y-axis and the Z-axis may be perpendicular to each other, or may represent different directions that are not perpendicular to each other. For objectives of the present disclosure, “at least one selected from X, Y or Z” and “at least one selected from a group consisting of X, Y and Z” may be interpreted as only X, only Y, only Z, or any combination of two or more of X, Y and Z, such as XYZ, XYY, YZ and ZZ. As used herein, the term “and/or” includes any and all combinations of one or more of the listed related items.

It should be noted that although the terms “first”, “second”, and so on may be used herein to describe various components, members, elements, regions, layers and/or portions, these components, members, elements, regions, layers and/or portions should not be limited by these terms. Rather, these terms are used to distinguish one component, member, element, region, layer and/or portion from another one. Thus, for example, a first component, a first member, a first element, a first region, a first layer and/or a first portion discussed below may be referred to as a second component, a second member, a second element, a second region, a second layer and/or a second portion without departing from teachings of the present disclosure.

For ease of description, spatial relationship terms, such as “upper”, “lower”, “left”, “right”, may be used herein to describe a relationship between an element or feature and another element or feature as shown in the figures. It should be understood that the spatial relationship terms are intended to cover other different orientations of a device in use or operation in addition to the orientation described in the figures. For example, if a device in the figures is turned upside down, an element or feature described as “below” or “under” another element or feature will be oriented “above” or “on” the another element or feature.

It should be noted that the expression “the same layer” herein refers to a layer structure that is formed by firstly forming, using a same film forming process, a film layer used to form a specific pattern, and then patterning, using one-time patterning process, the film layer with a same mask. Depending on different specific patterns, the one-time patterning process may include a plurality of exposure, development or etching processes, and the specific pattern in the formed layer structure may be continuous or discontinuous. That is, a plurality of elements, components, structures and/or portions located in “the same layer” are made of the same material and formed by the same patterning process. Generally, a plurality of elements, components, structures and/or portions located in “the same layer” have substantially the same thickness.

Those skilled in the art should understand that, unless otherwise specified, the expression “height” or “thickness” herein refers to a size in a direction perpendicular to a surface of each film layer provided on the display substrate, that is, a size in a light emitting direction of the display substrate, or called a size in a normal direction of the display device.

Herein, directional expressions such as “first direction” and “second direction” are used to describe different directions along a pixel region, such as a vertical direction and a horizontal direction of the pixel region, or a row direction and a column direction of a sub-pixel arrangement. It should be understood that such representations are merely illustrative descriptions and not limitations on the present disclosure.

Transistors used in embodiments of the present disclosure may all be thin film transistors or field effect transistors or other devices with the same characteristics. Since the thin film transistor used herein have a source electrode and a drain electrode symmetrical to each other, the source electrode and the drain electrode may be interchanged. In the embodiments of the present disclosure, the transistor may include a gate electrode, a first electrode and a second electrode. The first electrode may represent one of the source electrode and the drain electrode, and the second electrode may represent the other of the source electrode and the drain electrode. In the following examples, a case of a P-type thin film transistor serving as a driving transistor is mainly described, and the other transistors are of the same or different types as or from the driving transistor according to a circuit design. Similarly, in other embodiments, the driving transistor may also be shown as an N-type thin film transistor.

Herein, the expression “PPI” (Pixels Per Inch) represents a pixel density, which represents a number of pixels per inch. Generally, the higher the PPI value, the higher the density at which the display device may display an image.

Some exemplary embodiments of the present disclosure provide a display device, including: a base substrate; a reflective assembly on a side of the base substrate, where the reflective assembly includes a reflective assembly upper end surface away from the base substrate, the reflective assembly upper end surface is provided with a plurality of protruding portions, a side tangent of the protruding portion has a first angle θ₁ with the reflective assembly upper end surface, and the side tangent is a tangent of a side edge between a lowest point and a highest point of the protruding portion at a midpoint position; a display assembly on a side of the reflective assembly away from the base substrate, where the display assembly includes a liquid crystal layer having a first refractive index n₁; and a light emitting assembly on a side of the display assembly away from the base substrate, where the light emitting assembly includes: a light guide plate having a second refractive index n₂, where the light guide plate includes a light guide plate upper end surface away from the base substrate and a light guide plate peripheral side surface, the light guide plate upper end surface is provided with a plurality of first recessed portions recessed in a direction towards the base substrate, and an inclined side surface of the first recessed portion facing the light guide plate peripheral side surface has a second angle θ₂ with the light guide plate upper end surface; and a light source opposite to the light guide plate peripheral side surface, where the light source is used to emit a light ray towards the light guide plate peripheral side surface, and the light ray has a third angle θ₃ with the light guide plate peripheral side surface, where the second angle θ₂ meets a relationship of:

θ₂=90°−½[arccos(1/n₂×sin θ₃)+arcsin(n₁/n₂×sin 2θ₁)].

In the display device according to the embodiments of the present disclosure, the light guide plate is made of a glass material, which may be applied to an outdoor high temperature environment and also to an ultraviolet light irradiation environment, without the problem of yellowing of the light guide plate. In addition, by setting the relationship between the first angle of the protruding portion, the second angle, and the third angle of the light ray, it is possible to effectively improve a light extraction efficiency of the light guide plate, and also enhance the contrast and display uniformity of the display device.

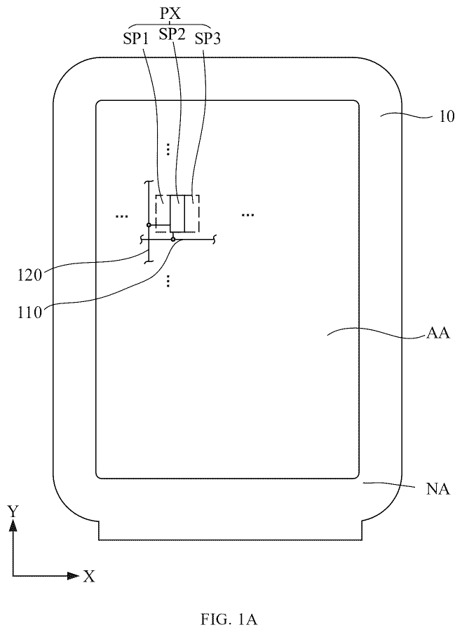

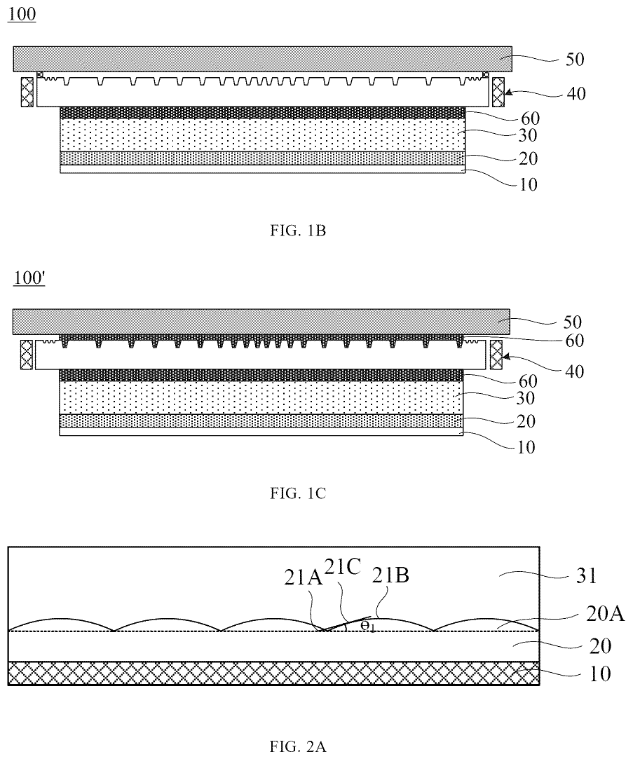

FIG. 1A shows a schematic diagram of a planar structure of a display substrate according to an exemplary embodiment of the present disclosure. FIG. 1B shows a schematic diagram of a cross-sectional structure of the display substrate according to an exemplary embodiment of the present disclosure, taken along section line B-B in FIG. 1A. FIG. 1C shows a schematic diagram of a cross-sectional structure of the display substrate according to another exemplary embodiment of the present disclosure, taken along section line B-B in FIG. 1A.

As shown in FIG. 1A to FIG. 1C, a display device 100 of the embodiments of the present disclosure includes a base substrate 10, a reflective assembly 20, a display assembly 30, and a light emitting assembly 40.

As shown in FIG. 1A, the display substrate may include a display region AA and a non-display region NA. The display region AA may be a region in which pixel units PX for displaying an image are provided. Each pixel unit will be described later. The non-display region NA is a region in which no pixel unit PX is provided, that is, a region in which no image is displayed. The non-display region NA corresponds to a bezel in a final display device, and a width of the bezel may be determined according to a width of the non-display region NA.

The display region AA may have various shapes. For example, the display region AA may be provided in various shapes such as a closed polygon including straight sides (e.g., a rectangle), a circle or an ellipse, etc. including a curved side, and a semicircle or a semi-ellipse, etc. including a straight side and a curved side. In the embodiments of the present disclosure, the display region AA is provided as a region having a quadrangular shape including straight sides. It should be understood that this is merely an exemplary embodiment of the present disclosure, rather than a limitation to the present disclosure.

The non-display region NA may be arranged on at least one side of the display region AA. In the embodiments of the present disclosure, the non-display region NA may surround a periphery of the display region AA. In the embodiments of the present disclosure, the non-display region NA may include a lateral portion extending in a first direction X and a longitudinal portion extending in a second direction Y.

The pixel units PX are arranged in the display region AA. A pixel unit PX is a minimum unit for displaying image, and a plurality of pixel units may be provided. For example, the pixel unit PX may include light emitting devices that emit white light and/or color light.

A plurality of pixel units PX may be provided in a form of a matrix along rows extending in the first direction X and columns extending in the first direction Y. However, the embodiments of the present disclosure do not specifically limit an arrangement form of the pixel units PX, and the pixel units PX may be arranged in various forms. For example, the pixel units PX may be arranged such that a direction inclined with respect to the first direction X and the first direction Y is a column direction, and a direction intersecting the column direction is a row direction.

In other words, a plurality of pixel units PX are arranged in an array in the first direction X and the second direction Y, so as to form a plurality of rows of pixel units and a plurality of columns of pixel units.

A pixel unit PX may include a plurality of sub-pixels. For example, a pixel unit PX may include three sub-pixels, namely a first sub-pixel SP1, a second sub-pixel SP2, and a third sub-pixel SP3. For example, the first sub-pixel SP1 may be a red sub-pixel, the second sub-pixel SP2 may be a green sub-pixel, and the third sub-pixel SP3 may be a blue sub-pixel.

It should be noted that in the embodiments of the present disclosure, the number of sub-pixels included in a pixel unit is not particularly restricted, and is not limited to three as described above.

As shown in FIG. 1B and FIG. 1C, the base substrate 10, the reflective assembly 20, the display assembly 30 and the light emitting assembly 40 of the display device 100 are arranged in a stack structure. Specifically, the reflective assembly 20 is arranged on a side of the base substrate 10, the display assembly 30 is arranged on a side of the reflective assembly 20 away from the base substrate, and the light emitting assembly 40 is arranged on a side of the display assembly 30 away from the base substrate. In addition, a touch assembly 50 is provided on a side of the light emitting assembly 40 away from the base substrate. Exemplarily, the base substrate 10 may be a glass substrate.

As shown in FIG. 1B, in an embodiment of the present disclosure, an edge lamination process is adopted between the touch assembly 50 and the light emitting assembly 40. For example, the touch assembly 50 is in a flat plate shape, and the touch assembly 50 is bonded to the light emitting assembly 40 at a peripheral position of the flat plate shape, for example, by using an OCR adhesive. A filling medium such as air is filled in a middle position of the flat plate shape of the touch assembly 50.

As shown in FIG. 1C, in another embodiment of the present disclosure, a full lamination process is adopted between the touch assembly 50 and the light emitting assembly 40. For example, a bonding adhesive 60 is filled between the touch assembly 50 and the light emitting assembly to fully bond the touch assembly and the light emitting assembly.

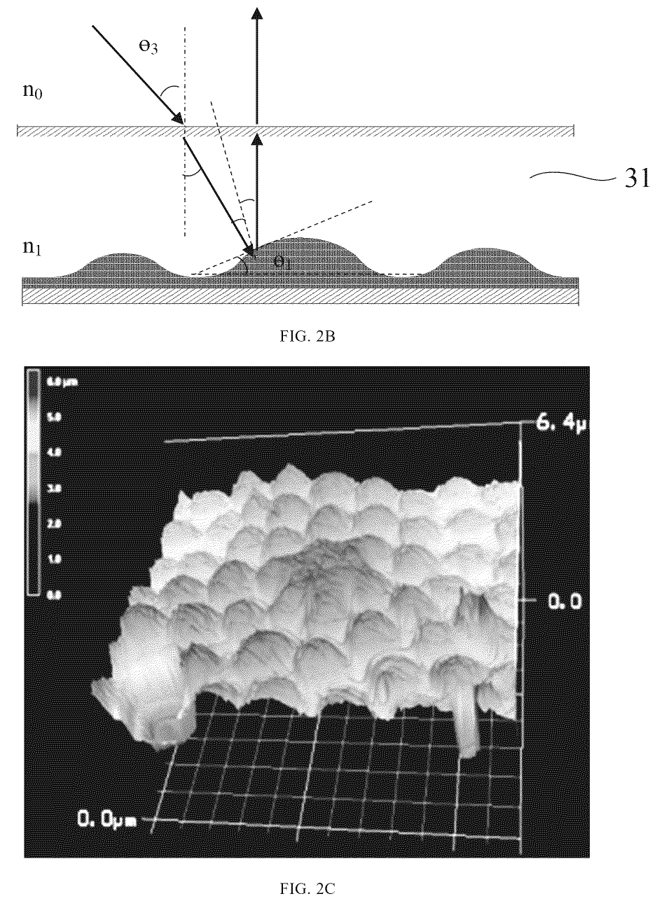

Various structures of the display device in the embodiments of the present disclosure will be described in detail below with reference to FIG. 2A to FIG. 8B.

FIG. 2A shows a schematic diagram of a cross-sectional structure of a reflective assembly according to an exemplary embodiment of the present disclosure. FIG. 2B shows a schematic diagram of an optical path entering a liquid crystal layer by the reflective assembly according to an exemplary embodiment of the present disclosure. FIG. 2C shows a schematic diagram of a surface morphology of the reflective assembly according to an exemplary embodiment of the present disclosure.

As shown in FIG. 2A and FIG. 2B, the reflective assembly 20 is arranged on a side of the base substrate 10, and the reflective assembly 20 includes a reflective assembly upper end surface 20A away from the base substrate. The reflective assembly upper end surface is provided with a plurality of protruding portions 21, and a side tangent of the protruding portion 21 has a first angle θ₁ with the reflective assembly upper end surface 20A. The side tangent refers to a tangent of a side edge between a lowest point and a highest point of the protruding portion at a midpoint position.

The reflective assembly upper end surface 20A may refer to a plane on a side away from the base substrate, and a plurality of protruding portions 21 facing away from the base substrate are provided on that plane. The protruding portion 21 may be, for example, a protrusion in the shape of a spherical crown, and the side tangent of the protruding portion has the first angle θ₁ with the reflective assembly upper end surface. The protruding portion 21 has a lowest point 21A and a highest point 21B, a side edge between the lowest point and the highest point has a midpoint 21C, and a tangent of the side edge at the midpoint 21C is the side tangent. The angle between the side tangent and the reflective assembly upper end surface 20A may be, for example, an angle between a tangent at a midpoint of an edge corresponding to a cross section of the protruding portion and the reflective assembly upper end surface corresponding to the cross section of the protruding portion.

Exemplarily, the first angle θ₁ is in a range of 5°≤θ1≤15°, and the protruding portions 21 are irregularly arranged on the reflective assembly upper end surface, so that light incident on the reflective assembly upper end surface may be diffusely reflected to ensure a better uniformity of the reflected light on the display device. For example, by setting the first angle θ₁ in the above-mentioned range, it may be ensured that a reflectivity uniformity of the reflective assembly is greater than or equal to 85%.

As shown in FIG. 2B, the protruding portion 21 on the reflective assembly upper end surface 20A is circular or approximately circular, which may ensure a good diffuse reflection effect of the protruding portion 21.

In the embodiments of the present disclosure, the display assembly 30 is arranged on the side of the reflective assembly 20 away from the base substrate 10, and the display assembly 30 includes a liquid crystal layer 31 having a first refractive index n₁.

The liquid crystal layer 31 of the display assembly includes a plurality of pixel units arranged in an array in the first direction X and the second direction Y. The first direction X intersects with the second direction Y. For example, the first direction X is perpendicular to the second direction Y. Each of the plurality of pixel units includes a plurality of sub-pixels arranged sequentially in the first direction, and a length direction of each sub-pixel extends in the second direction. For example, the red sub-pixel R, the green sub-pixel G and the blue sub-pixel B are arranged sequentially in the first direction, and the length direction of the red sub-pixel R, the length direction of the green sub-pixel G and the length direction of the blue sub-pixel B are parallel to the second direction Y.

As shown in FIG. 2B, a light ray is incident on the liquid crystal layer 31 from an upper side of the display assembly, then refracted by the liquid crystal layer 31 to reach the protruding portion 21, then reflected by the protruding portion 21, and finally exits from the side of the display assembly away from the base substrate. An optical path of the light ray being incident on the side of the display assembly away from the base substrate, passing through the liquid crystal layer 31 to reach the reflective assembly 20, then being reflected to re-enter the liquid crystal layer 31 and exiting from the side of the display assembly away from the base substrate is shown in FIG. 2B, in which θ₀ represents an incident angle of the light ray on the liquid crystal layer of the display assembly, no represents a refractive index of a medium on the side of the display assembly away from the base substrate, θ₁ represents a first angle between the side tangent of the protruding portion 21 and the reflective assembly upper end surface, and n₁ represents a refractive index of the liquid crystal layer.

As shown in the surface morphology of the reflective assembly 20 in FIG. 2C, a plurality of protruding portions are provided on the side of the reflective assembly away from the base substrate, thereby achieving a diffuse reflection effect on the incident light.

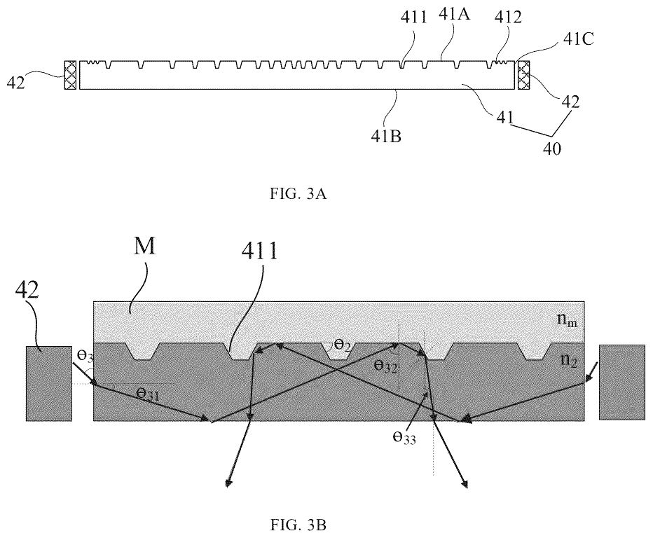

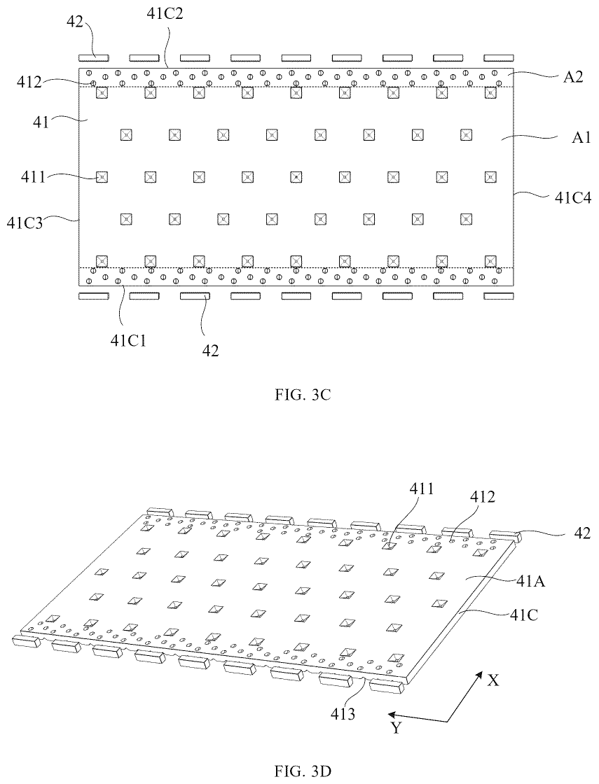

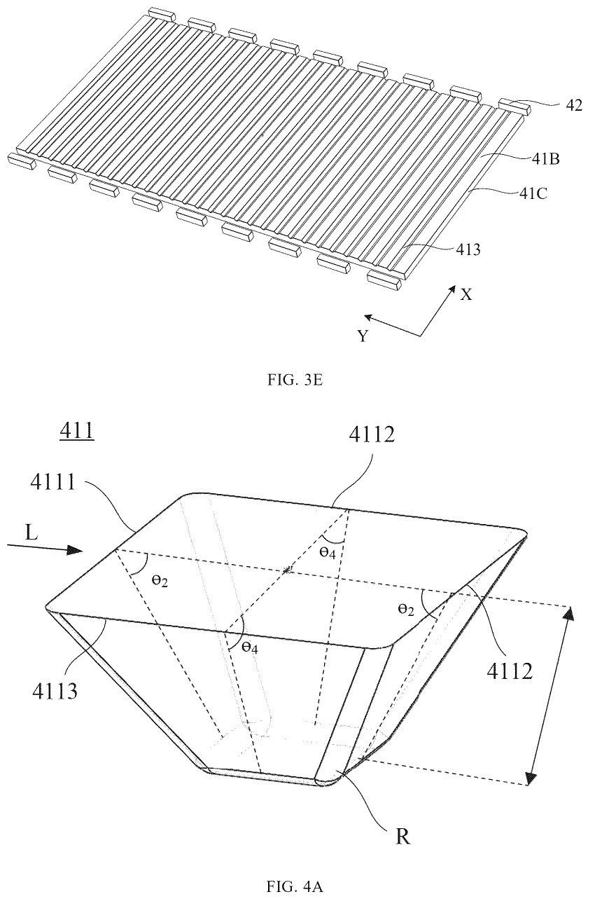

FIG. 3A shows a schematic diagram of a cross-sectional structure of a light emitting assembly according to an exemplary embodiment of the present disclosure. FIG. 3B shows a schematic diagram of an optical path after a light source of the light emitting assembly enters a light guide plate according to an exemplary embodiment of the present disclosure. FIG. 3C shows a schematic diagram of a planar structure of the light emitting assembly according to an exemplary embodiment of the present disclosure. FIG. 3D shows a schematic diagram of a three-dimensional structure of the light emitting assembly from a viewing angle according to an exemplary embodiment of the present disclosure. FIG. 3E shows a schematic diagram of a three-dimensional structure of the light emitting assembly from another viewing angle according to an exemplary embodiment of the present disclosure.

The light emitting assembly 40 is arranged on the side of the display assembly 30 away from the base substrate 10. As shown in FIG. 3A, the light emitting assembly 40 includes a light guide plate 41 and a light source 42. In some embodiments of the present disclosure, the light guide plate 41 may be, for example, a circular plate, or a polygonal plate, such as a pentagonal plate, etc. The light guide plate 41 includes a light guide plate upper end surface 41A and a light guide plate lower end surface 41B opposite to each other, and a light guide plate peripheral side surface 41C on a periphery of the light guide plate. The light guide plate upper end surface 41A refers to a surface away from the base substrate 10, and the light guide plate lower end surface 41B refers to a surface close to the base substrate 10.

The light source 42 is arranged on the light guide plate peripheral side surface 41C, for example, at a partial position of the light guide plate peripheral side surface, or at an entire position of the light guide plate peripheral side surface.

As shown in FIG. 3A to FIG. 3E, the light guide plate 41 may be a quadrilateral plate, such as a rectangular plate.

An orthographic projection of the light guide plate 41 on the base substrate is a quadrilateral. For example, as shown in FIG. 3C, the orthographic projection of the light guide plate on the base substrate is a rectangle.

As shown in FIG. 3C and FIG. 3D, the light guide plate 41 has four light guide plate peripheral side surfaces, namely a first peripheral side surface 41C1 and a second peripheral side surface 41C2 opposite to each other, and a third peripheral side surface 41C3 and a fourth peripheral side surface 41C4 opposite to each other. The third peripheral side surface 41C3 and the fourth peripheral side surface 41C4 are each connected and perpendicular to the first peripheral side surface 41C1 and the second peripheral side surface 41C2, so that the light guide plate 41 is formed as a rectangle.

The light source 42 is arranged opposite to the first peripheral side surface 41C1 and the second peripheral side surface 41C2 respectively.

As shown in FIG. 3C to FIG. 3E, the light guide plate light guide plate upper end surface 41A of the light guide plate 41 includes a first region A1 and a second region A2. An orthographic projection of the first region A1 on the base substrate overlaps partially with an orthographic projection of the liquid crystal layer 31 of the display assembly 30 on the base substrate. The second region A2 is located between the first region A1 and the light guide plate peripheral side surface 41C. For example, the first region A1 is a region close to a center of the light guide plate upper end surface 41A, and the second region A2 is a region on both sides of the first region A1. As shown in FIG. 3C, two second regions are located on both sides of the first region respectively.

The light guide plate upper end surface 41A is provided with a plurality of first recessed portions 411 recessed in a direction towards the base substrate. An inclined side surface of the first recessed portion 411 facing the light guide plate peripheral side surface has a second angle θ₂ with the light guide plate upper end surface, and the first recessed portions 411 are arranged in the first region A1.

The light source 42 may emit a light ray towards the light guide plate peripheral side surface 41C, and the light ray has a third angle θ₃ with the light guide plate peripheral side surface. Exemplarily, the light source is a Lambertian light source. As shown in FIG. 3B, the third angle θ₃ between the light ray emitted by the light source 42 and the light guide plate peripheral side surface 41C is in a range of 0°≤θ₃≤60°. In such embodiments, the third angle between the light ray emitted by the light source and the light guide plate peripheral side surface may refer to, for example, an angle between the light guide plate peripheral side surface in FIG. 3B and a light ray emitted from an upper side, or an angle between the light guide plate peripheral side surface in FIG. 3B and a light ray emitted from a lower side.

As shown in FIG. 3A and FIG. 3B, the light guide plate 41 has a second refractive index n₂. For example, the light guide plate 41 may be made of a glass material, and high refractive index particles such as titanium dioxide may be doped in the glass so that the second refractive index n₂ of the light guide plate is in a range of 1.7 to 2.1. The light guide plate made of a glass material may avoid problems such as yellowing during normal use of the display device. Furthermore, the second refractive index of the light guide plate within the above-mentioned range may ensure that the light guide plate has a good refractive effect on the light ray emitted from the light source.

The light guide plate upper end surface 41A is provided with a plurality of first recessed portions 411, and an inclined side surface of the first recessed portion 411 facing the light guide plate peripheral side surface has a second angle θ₂ with the light guide plate.

The second angle θ₂ meet a relationship of:

$${⊖}_{2} = 90 - \frac{1}{2} [ arccos ( \frac{1}{{n}_{2}} \times sin {θ}_{3} ) + arcsin ( \frac{{n}_{1}}{{n}_{2}} \times sin 2 {⊖}_{1} ) ] .$$

A medium M, such as air or bonding adhesive, is provided on the side of the light guide plate 41 away from the base substrate, and different media may have different refractive indexes nₘ. For example, when an edge lamination is adopted for the touch assembly, the medium is air, and nₘ=nₐᵢᵣ=1; while when a full lamination is adopted for the touch assembly, the medium is an OCA adhesive, then the refractive index nₘ of the medium is in a range of 1.4 to 1.52.

As shown in FIG. 3B, the light ray from the light source 42 has a third angle θ₃ before entering the light guide plate 41, and is then refracted to have an incident angle θ₃₁ after entering the light guide plate, then transmitted in total reflection on the light guide plate lower end surface, and undergoes a total reflection again on the light guide plate upper end surface with a reflection angle θ₃₂. A transmission angle is greater than a critical angle of total reflection, as shown in Equation (1) below.

$${θ}_{32} > {θ}_{c} = arcsin ( \frac{{n}_{m}}{{n}_{2}} )$$

When reaching the first recessed portion 411, the light ray is transmitted in total reflection on the inclined side surface of the first recessed portion 411 and is transmitted to the light guide plate lower end surface 41B. The transmission angle θ₃₃ is less than the total reflection angle, and the light ray enters the display assembly and the reflective assembly. The front light exit angle θ₃₃ meets Equation (2) below.

$${θ}_{33} = 1 \; 80 - arccos ( \frac{1}{{n}_{2}} \times {sin θ}_{3} ) - 2 {θ}_{2}$$

The front light exit angle is consistent with a desired angle of the reflective assembly, which is shown in Equation (3) below.

$${n}_{2} * {sin θ}_{33} = sin {θ}_{0}$$

According to Equations (1), (2) and (3) mentioned above, it may be determined that the second angle θ₂ between the inclined side surface of the first recessed portion facing the light guide plate peripheral side surface and the light guide plate upper end surface meets Equation (4) below.

$${⊖}_{2} = 90 - \frac{1}{2} [ arccos ( \frac{1}{{n}_{2}} \times sin {θ}_{3} ) + arcsin ( \frac{{n}_{1}}{{n}_{2}} \times sin 2 {⊖}_{1} ) ]$$

When the second angle θ₂ meets the above-mentioned equation, the light emitting assembly 40 may refract light well, so that the light source of the display device has a good display uniformity.

In some embodiments of the present disclosure, due to the provision of the first recessed portion 411, the light ray incident on the light guide plate peripheral side surface 41C may undergo total reflection on the light guide plate lower end surface 41B, the light guide plate upper end surface 41A and the inclined surface of the first recessed portion 411. A calculation of reflection does not involve nₘ, but a condition for total reflection is n₂>nₘ. In such embodiments, by setting nₘ<n₂, it is possible to achieve a total reflection of light ray in the light guide plate, thereby improving the display uniformity.

In the embodiments of the present disclosure, the second angle θ₂ is in a range of 35°≤θ₂≤50°.

In some embodiments of the present disclosure, the refractive index of the liquid crystal layer 31 may be, for example, n₁=1.5.

In some exemplary embodiments of the present disclosure, a distribution density ρ of the first recessed portions 411 in the first region A1 gradually increases in a direction from a position close to the light guide plate peripheral side surface 41C to a position away from the light guide plate peripheral side surface. By setting the density distribution of the first recessed portions 411, the first recessed portion 411 of the light guide plate 41 at a position away from the light source may refract more light rays, so as to achieve a good brightness uniformity, such as a brightness uniformity of over 80%, and then the display device may have a good display effect.

In some exemplary embodiments of the present disclosure, the first recessed portion 411 includes a quadrangular pyramid-shaped recessed portion, a conical recessed portion or a circular frustum-shaped recessed portion. In some optional embodiments, the first recessed portion 411 may further include recessed portions in other shapes.

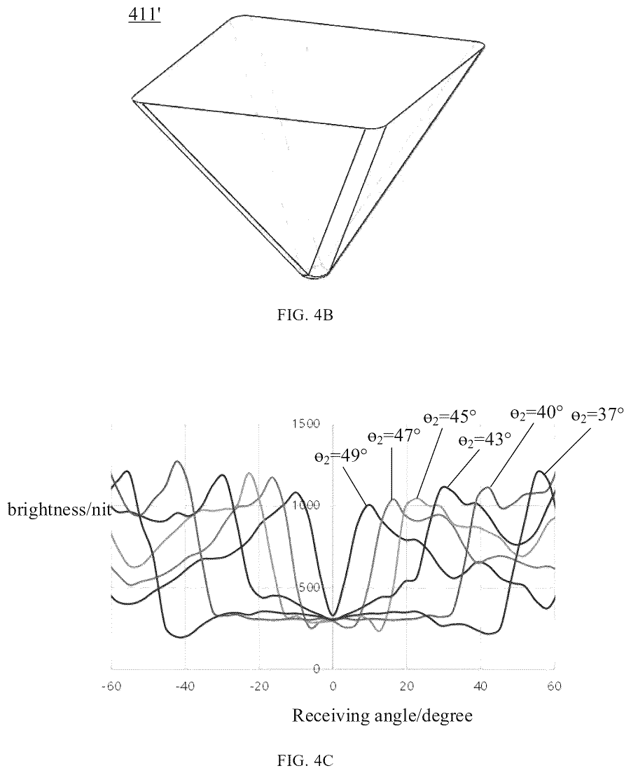

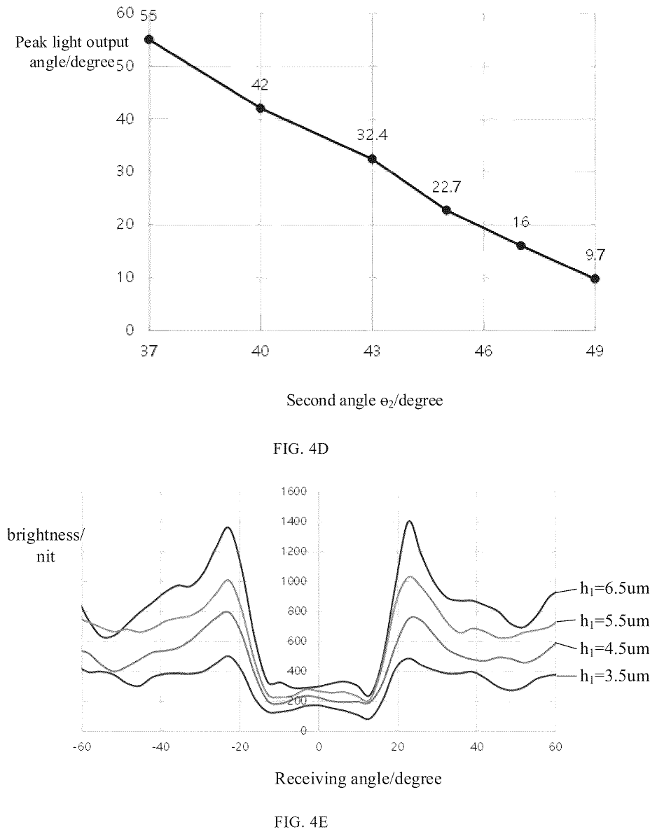

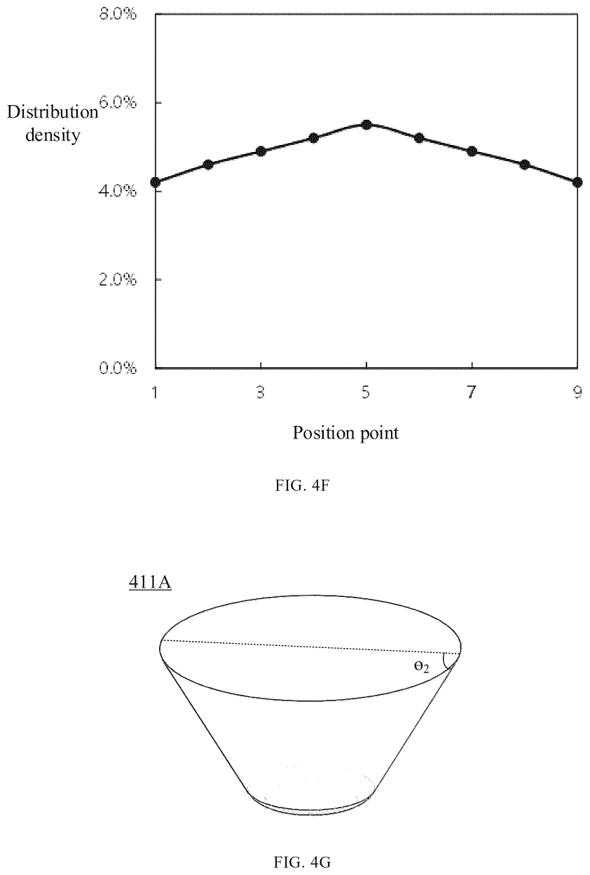

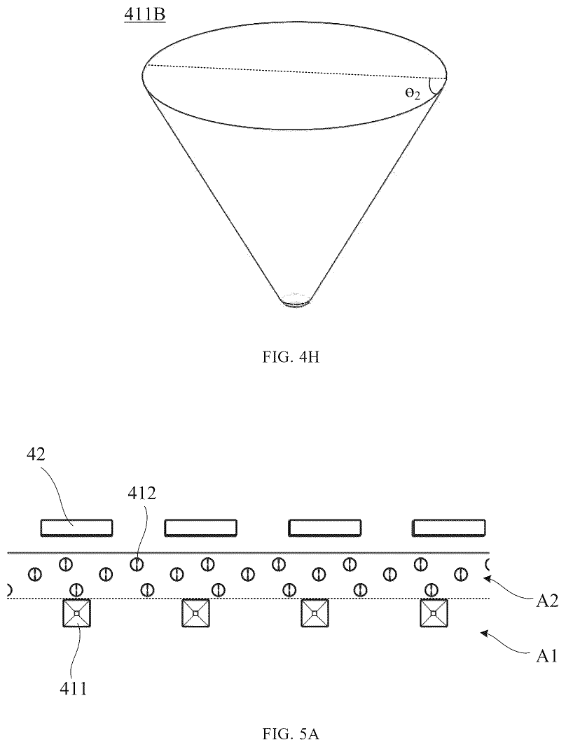

FIG. 4A shows a schematic structural diagram of a first recessed portion on the light emitting assembly according to an exemplary embodiment of the present disclosure. FIG. 4B shows a schematic structural diagram of the first recessed portion on the light emitting assembly according to another exemplary embodiment of the present disclosure. FIG. 4C shows a relationship curve between a second angle and a light output brightness of a light guide plate lower end surface according to an exemplary embodiment of the present disclosure. FIG. 4D shows a relationship curve between the second angle and a peak light output angle at the light guide plate lower end surface according to an exemplary embodiment of the present disclosure. FIG. 4E shows a relationship curve between a depth of the first recessed portion and the light output brightness of the light guide plate lower end surface according to an exemplary embodiment of the present disclosure. FIG. 4F shows a distribution density curve of the first recessed portions on the light guide plate according to an exemplary embodiment of the present disclosure. FIG. 4G shows a schematic structural diagram of the first recessed portion on the light emitting assembly according to an exemplary embodiment of the present disclosure. FIG. 4H shows a schematic structural diagram of the first recessed portion on the light emitting assembly according to another exemplary embodiment of the present disclosure.

As shown in FIG. 4A and FIG. 4B, the first recessed portion 411 includes a quadrangular pyramid-shaped recessed portion, which includes: a first inclined side surface 4111 facing the first peripheral side surface 41C1, a second inclined side surface 4112 opposite to the first inclined side surface 4111 and facing the second peripheral side surface 41C2, a third inclined side surface 4113 located between the first inclined side surface 4111 and the second inclined side surface 4112 and facing the third peripheral side surface 41C3, and a fourth inclined side surface 4114 opposite to the third inclined side surface 4113 and facing the fourth peripheral side surface 41C4. The first inclined side surface 4111 and the second inclined side surface 4112 respectively form the second angle θ₂ with the light guide plate upper end surface 41A. The third inclined side surface and the fourth inclined side surface respectively form a fourth angle θ₄ with the light guide plate upper end surface. The second angle θ₂ is less than the fourth angle θ₄, and the fourth angle θ₄ is less than or equal to 80°.

As shown in FIG. 4A, the first recessed portion 411 includes a quadrangular pyramid-shaped recessed portion, where a top of the quadrangular pyramid-shaped recessed portion is cut off to form a frustum-shaped structure. As shown in FIG. 4B, a first recessed portion 411′ is a quadrilateral frustum, that is, a top of the quadrangular pyramid-shaped recessed portion is not cut off and the quadrangular pyramid-shaped recessed portion has a pyramid top facing the base substrate. The shape of the first recessed portion may be set according to actual needs, and the second angle between the inclined side surface of the first recessed portion facing the light guide plate peripheral side surface and the light guide plate upper end surface needs to meet Equation (4) to ensure a good uniformity and a good display effect of the display device.

According to the embodiments of the present disclosure, the second angle θ₂ is less than the fourth angle θ₄. Since the first inclined side surface 4111 and the second inclined side surface 4112 respectively face a light incidence direction L, the first inclined side surface 4111 and the second inclined side surface 4112 may have a large contact area with the light ray emitted by the light source, so that the light guide plate lower end surface 41A of the light emitting assembly 40 may form a small-angle symmetrical light output, and a light output angle on the light guide plate upper end surface is greater than 80°, which greatly improves the contrast of the display device when the user faces the display device and reduces a light output difference between left and right viewing angles when the user views the display device, thereby improving the uniformity of the display device and effectively improving the brightness of the display device.

In the embodiments of the present disclosure, a size of the second angle θ₂ mainly determines the light output angle at the light guide plate lower end surface 41A. As shown in FIG. 4C and FIG. 4D, the peak light output angle at the light guide plate lower end surface 41A gradually decreases as the second angle θ₂ increases. According to the light source direction L, the relationship between the second angle θ₂ and the fourth angle θ₄ is set to θ₂≤θ₄≤80° and the fourth angle is appropriately increased, then the contact area between the light ray and the first recessed portion may be increased, which may help improve brightness.

As shown in FIG. 4A, a connecting chamfer R is formed between the inclined side surfaces of the quadrangular pyramid-shaped recessed portion. The connecting chamfer R may result in a decrease of the contact area between the first inclined side surface 4111 and the incident light from the light source and the contact area between the second inclined side surface 4112 and the incident light from the light source, which may lead to a decrease in a light extraction ability of the first recessed portion 411. Therefore, the connecting chamfer R less than or equal to 1.5 μm may ensure a good light extraction effect of the first recessed portion.

As shown in the curve of the peak brightness of the light guide plate lower end surface 41B changing with a height h1 of the quadrangular pyramid in FIG. 4E, the peak brightness of the light guide plate lower end surface gradually increases as h1 increases. In the embodiments of the present disclosure, as the peak brightness of the light guide plate lower end surface increases with the height of the quadrangular pyramid, a depth of the quadrangular pyramid-shaped recessed portion recessed in a direction towards the base substrate is set to h1, where 3 μm≤h1≤8 μm.

In some embodiments of the present disclosure, the distribution density ρ of the first recessed portions is set to ensure that the first recessed portions 411 may significantly improve the display uniformity of the display device. Specifically, the light source 42 is arranged on the light guide plate peripheral side surface 41C. As the light ray from the light source 42 enters the light guide plate 41, the brightness of the light ray may attenuate. In order to improve the light extraction effect of the first recessed portion 411, the distribution density value ρ of the first recessed portions 411 is designed to achieve a good light extraction effect and improve the display uniformity of the display device.

Exemplarily, it is possible to calculate a dot spacing Pₙ of the first recessed portions in a unit area S₂ to finally determine the distribution density value ρ of the first recessed portions. The dot spacing Pₙ of the first recessed portions refers to a distance between adjacent first recessed portions in a direction opposite to the light source. The dot spacing Pₙ of the first recessed portions in the unit area S₂ is calculated using Equation (5).

$$\{ \begin{matrix}{A}_{n} = {A}_{n 1} \times [ 1 - K \times {( 1 - Z )}^{n - 1} ] \\ {P}_{n} = L \times \frac{{A}_{n - 1} - {A}_{n}}{{A}_{0} - {A}_{n}} \times \frac{1}{10} \\ {B}_{n} = {B}_{n - 1} \times [ 1 - K \times {( 1 - Z )}^{n - 1} ] \\ {A}_{0} + {B}_{9} = {A}_{1} + {B}_{8} = ⋯ = {A}_{8} + {B}_{1} = {A}_{9} + {B}_{0}\end{matrix}$$

where Aₙ or Bₙ represents a single-sided luminous flux of the light source at a particular distance from the light guide plate peripheral side surface, for example, Aₙ may represent a single-sided luminous flux of the light source located on the first light guide plate peripheral side surface at a particular distance from the first light guide plate peripheral side surface, and Bₙ may represent a single-sided luminous flux of the light source located on the second light guide plate peripheral side surface at a particular distance from the second light guide plate peripheral side surface, K represents an initial light extraction efficiency of the first recessed portion, and Z represents an attenuation coefficient of the light extraction ability of the first recessed portion with an optical path. The dot spacing Pₙ of the first recessed portions determines the number N of first recessed portions per unit area, which may be calculated using Equation (6) below.

$$N = {( \frac{1}{{P}_{n}} + 1 )}^{2}$$

A dot distribution density ρ of the first recessed portions may be calculated using Equation (7) below.

$$ρ = \frac{N \times {S}_{1}}{{S}_{2}}$$

where S₁ represents an opening area of the first recessed portion, and S₂ represents a unit area.

According to the above steps, it may be determined that the distribution density ρ of the first recessed portions 411 in the first region A1 gradually increases in a direction from a position close to the light guide plate peripheral side surface 41C to a position away from the light guide plate peripheral side surface 41C, as shown in FIG. 4F. That is, a variation trend of the distribution density of the first recessed portions is presented as follows. The distribution density gradually increases from the first peripheral side surface 41C1 towards the second peripheral side surface 41C2, then reaches a maximum value at a midpoint position between the first peripheral side surface 41C1 and the second peripheral side surface 41C2, and then gradually decreases from the midpoint position to the second peripheral side surface 41C2. As a result, it may be ensured that the brightness uniformity reaches over 83% when viewed from a top side of the display device.

In some embodiments of the present disclosure, when the distribution density ρ of the first recessed portions is set in a range of 4%≤ρ≤10%, the brightness uniformity of the light emitting assembly may be ensured, and the display effect of the display device may be improved.

As shown in the relationship curve between the second angle and the light output brightness of the light guide plate lower end surface in FIG. 4C, a receiving angle of a detector increases for the same light output brightness as the second angle θ₂ decreases, resulting in a decrease in the brightness uniformity. As shown in the relationship curve between the second angle and the peak light output angle at the light guide plate lower end surface in FIG. 4D, the peak light output angle at the light guide plate lower end surface decreases as the second angle increases. In order to ensure a good brightness uniformity, the second angle θ₂ is set in a range of 35°≤θ₂≤50°, thereby improving the display effect of the display device.

As shown in FIG. 4G, the first recessed portion is a circular frustum-shaped recessed portion 411A, and an opening diameter of the circular frustum-shaped recessed portion 411A gradually decreases in a direction towards the base substrate. A side generatrix of the circular frustum-shaped recessed portion has the second angle θ₂ with the light guide plate upper end surface, that is, if the circular frustum-shaped recessed portion is cut according to a central axis, an inclined side edge of a corresponding section is a generatrix, a line of the section on the light guide plate upper end surface is the light guide plate upper end surface, and the second angle θ₂ is formed as shown in FIG. 4G. In such embodiments, a bottom of the circular frustum-shaped recessed portion is a plane parallel to the light guide plate upper end surface, so that the light emitted from the reflective assembly may be emitted through the bottom of the circular frustum-shaped recessed portion, which may further improve the display uniformity.

As shown in FIG. 4H, the first recessed portion is a conical recessed portion 411B, and the generatrix of the conical recessed portion 411B forms a second angle θ₂ with the light guide plate upper end surface. In such embodiments, the conical recessed portion may improve the brightness uniformity of the light emitting assembly compared to a circular frustum-shaped recessed portion.

In some optional embodiments of the present disclosure, the first recessed portion may further include an n-sided pyramid-shaped recessed portion or an n-sided frustum-shaped recessed portion, and the inclined side surface of the n-sided pyramid-shaped recessed portion or n-sided frustum-shaped recessed portion facing the light guide plate peripheral side surface forms a second angle θ₂ with the light guide plate upper end surface. For example, the n-sided pyramid-shaped recessed portion or the n-sided frustum-shaped recessed portion may be applied to a structure where the light guide plate is a regular n-sided polygon, such as a regular pentagon, a regular hexagon, etc.

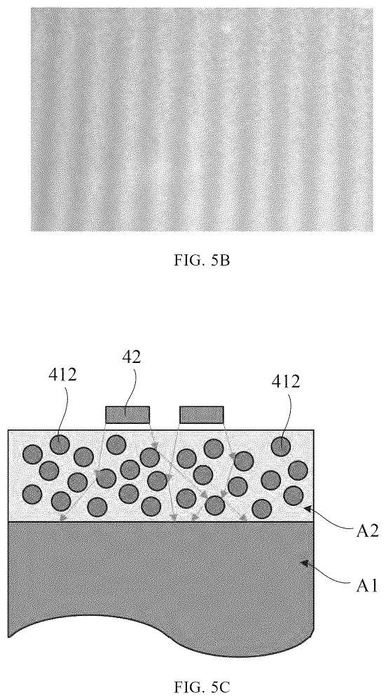

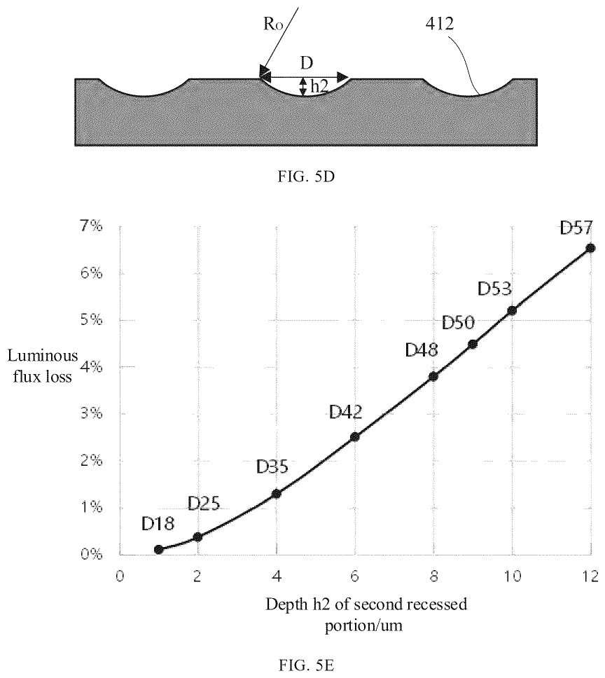

FIG. 5A shows a schematic structural diagram of a second recessed portion on the light emitting assembly according to an exemplary embodiment of the present disclosure. FIG. 5B shows a schematic diagram of a light source of the light emitting assembly generating a strip-shaped light beam in an exemplary embodiment. FIG. 5C shows a schematic diagram of light rays from a light source being transmitted in the second recessed portion according to an exemplary embodiment of the present disclosure. FIG. 5D shows a schematic diagram of a cross-sectional structure of the second recessed portion on the light emitting assembly according to an exemplary embodiment of the present disclosure. FIG. 5E shows a variation curve of a depth h2 of the second recessed portion and a luminous flux loss according to an exemplary embodiment of the present disclosure. FIG. 5F shows a variation curve of a distribution density of the second recessed portions and a luminous flux loss according to an exemplary embodiment of the present disclosure.

In some embodiments of the present disclosure, a plurality of second recessed portions 412 recessed in a direction towards the base substrate are uniformly provided in the second region A2 of the light guide plate upper end surface 41A, as shown in FIG. 5A. The second region A2 is a region between the light guide plate peripheral side surface 41C and the first region A1, and the second recessed portions 412 are uniformly arranged in the second region A2.

The light source 42 is provided on the light guide plate peripheral side surface 41C, and the light source 42 may be formed by a plurality of illuminators (such as LED lights) spaced apart along the light guide plate peripheral side surface. A spacing is formed between the plurality of illuminators, and a light intensity in a central region of the LED light is greater than that in other regions. Therefore, if the light mixing is not sufficient, strip-shaped light beams may appear as shown in FIG. 5B, resulting in a decrease in the display effect. By providing the second recessed portion, the incident light from the light source may be mixed, so that the occurrence of strip-shaped light beams may be reduced or even eliminated, and the display effect may be improved. As shown in FIG. 5C, when the light source emits light rays, the light rays enter the second region A2 of the light guide plate 41, and may be reflected in different directions after being incident on the second recessed portions 412, that is, the light rays may be mixed through the second recessed portions 412, thereby avoiding the occurrence of strip-shaped light beams.

In some embodiments of the present disclosure, the second recessed portion 412 includes a spherical crown-shaped recessed portion.

As shown in FIG. 5D, the second recessed portion 412 is recessed in a direction towards the base substrate 10 in the second region A2 of the light guide plate upper end surface 41A, so that an interface of the second recessed portion 412 is arc-shaped.

As shown in FIG. 5D, the spherical crown-shaped recessed portion has a depth h2 recessed in a direction towards the base substrate, 1 μm≤h2≤9 μm; the spherical crown-shaped recessed portion has a cross-sectional diameter D, 18 μm≤D≤50 μm. A relationship between D, h2, and a radius Ro of a sphere corresponding to the spherical crown-shaped recessed portion is as follows.

$$D = \sqrt{8 \times R o \times h 2 - 4 \times {( h 2 )}^{2}}$$

For example, Ro may be 40 μm, then values of h2 and D may be determined.

As shown in the curve of the depth h2 of the spherical crown-shaped recessed portion and the cross-sectional diameter D in FIG. 5E, as the cross-sectional diameter D increases and the depth h2 of the spherical crown-shaped recessed portion increases, a luminous flux loss generated by the second recessed portion gradually increases. In addition, as shown in the curve of the distribution density of the spherical crown-shaped recessed portions and the luminous flux loss generated by the second recessed portions in FIG. 5F, as the distribution density of the second recessed portions increases, the luminous flux loss gradually increases, and the luminous flux loss exceeds 5% when the distribution density of the spherical crown-shaped recessed portions is greater than 2%. By setting the distribution density value of the spherical crown-shaped recessed portions in the second region to less than or equal to 2%, the luminous flux loss may be ensured to be less than or equal to 5%. That is, the second recessed portion may generate a luminous flux loss while mixing light rays to prevent the occurrence of strip-shaped light beams. By setting the depth h2, the cross-sectional diameter D and the distribution density of the second recessed portions within the above-mentioned ranges, it is possible to reduce the luminous flux loss caused by the second recessed portion while preventing the occurrence of strip-shaped light beams.

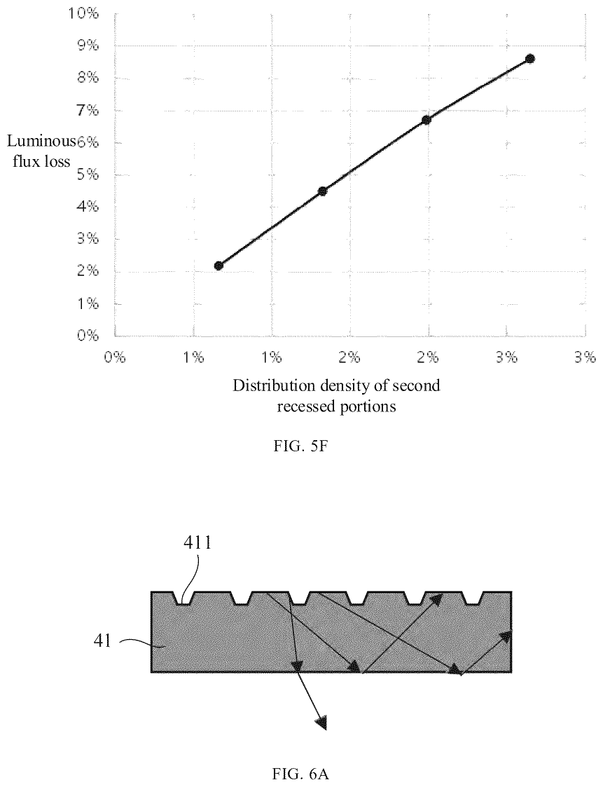

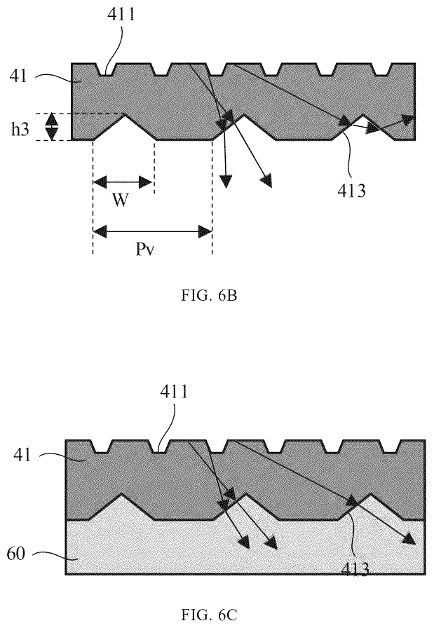

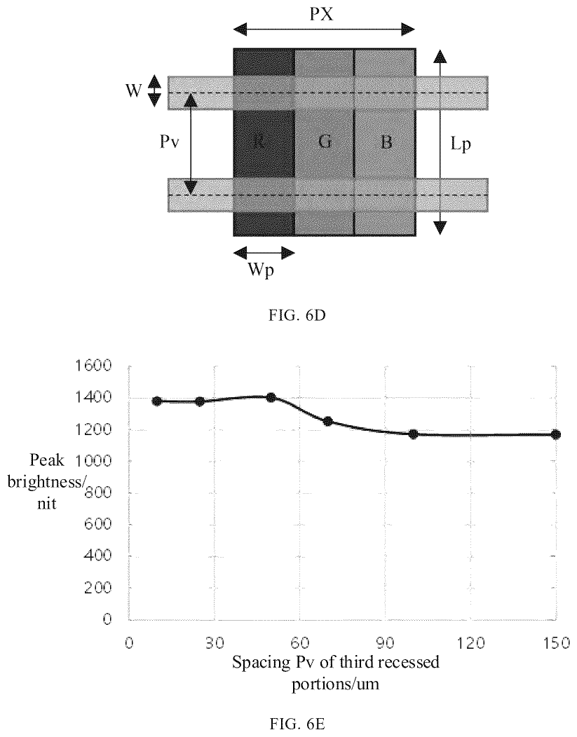

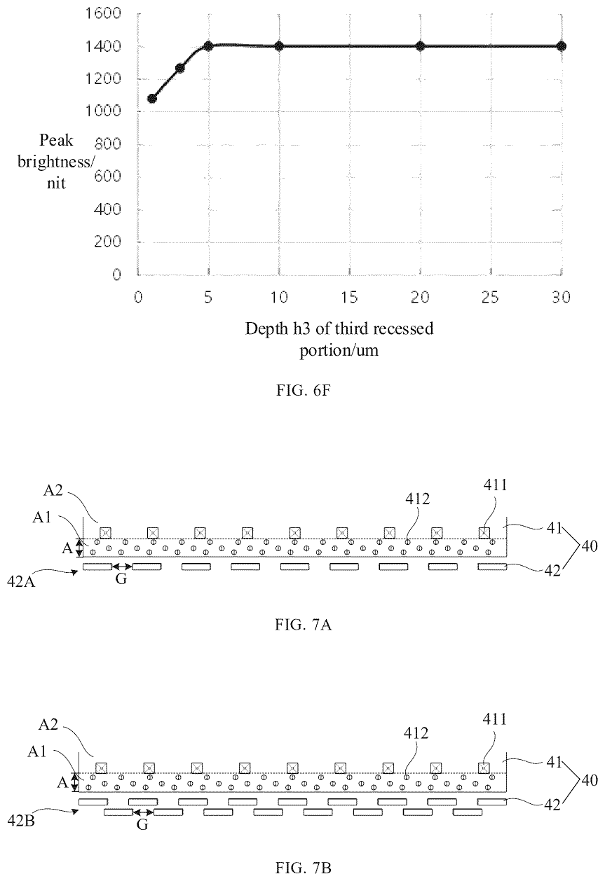

FIG. 6A shows a light transmission diagram in a case of no third recessed portion is provided on the light emitting assembly. FIG. 6B shows a schematic diagram of light rays being transmitted on the third recessed portion of the light emitting assembly according to an exemplary embodiment of the present disclosure. FIG. 6C shows a schematic diagram of light rays being transmitted on the third recessed portion of the light emitting assembly according to another exemplary embodiment of the present disclosure. FIG. 6D shows a schematic diagram of an arrangement relationship between the third recessed portions and pixel units on the light emitting assembly according to an exemplary embodiment of the present disclosure. FIG. 6E shows a relationship curve between a spacing of the third recessed portions and a peak light output brightness at the light guide plate lower end surface according to an exemplary embodiment of the present disclosure. FIG. 6F shows a relationship curve between a depth h3 of the third recessed portion and the peak light output brightness at the light guide plate lower end surface according to an exemplary embodiment of the present disclosure.

The light guide plate 41 includes a light guide plate lower end surface 41B close to the base substrate, and the light guide plate lower end surface 41B is opposite to the light guide plate upper end surface 41A. The light guide plate lower end surface 41B is provided with a third recessed portion 413 recessed in a direction away from the base substrate. The third recessed portion 413 is used to enhance the brightness of the light emitting assembly.

As shown in FIG. 3E and FIG. 6A, the third recessed portions 413 include V-shaped groove recessed portions, which extend in the first direction X and are spaced apart in the second direction Y. The V-shaped groove recessed portion is recessed in a direction away from the base substrate 10, and the V-shaped groove recessed portion has a depth h3 in the direction away from the base substrate, 1 μm≤h3≤30 μm. The V-shaped recessed portion has an opening width W in the second direction Y, 5 μm≤W≤30 μm.

When no third recessed portion 413 is provided on the light guide plate lower end surface 41B, as shown in FIG. 6A, light rays may enter the light guide plate from the light guide plate peripheral side surface 41, and large-angle light rays may not transcend total reflection to exit towards the light guide plate lower end surface, resulting in a decrease in the peak light output brightness at the light guide plate lower side surface. In the embodiments of the present disclosure, by providing the third recessed portion 413, as shown in FIG. 6B, it is possible to effectively destroy the totally reflected light at the light guide plate lower end surface 41B, so that the light rays may be emitted through the third recessed portion 413, thereby improving the peak light output brightness at the light guide plate lower end surface 41B. For example, compared to not providing the third recessed portion, providing the third recessed portion may increase the peak light output brightness by 15%. When an OCA adhesive is filled into the third recessed portion 413 on the light guide plate lower end surface 41B, as shown in FIG. 6C, the peak light output brightness at the light guide plate lower end surface is further increased because the OCA adhesive has a small refractive index difference from the glass of the light guide plate. For example, compared to not providing the third recessed portion, providing the third recessed portion 413 and filling the OCA adhesive in the third recessed portion 413 may increase the peak light output brightness by 50% to 80%, thereby improving the display effect of the display device. The refractive index of the OCA adhesive may be, for example, in a range of 1.4 to 1.52.

In some embodiments of the present disclosure, as shown in FIG. 6D, each pixel unit may include a plurality of sub-pixels arranged sequentially in the first direction X, such as a red sub-pixel R, a green sub-pixel G and a blue sub-pixel B arranged sequentially, and each sub-pixel has a length direction extending in the second direction Y. For example, the pixel unit may be set as a square, that is, a length PX and a width of the pixel unit are equal to a length Lp of the sub-pixel and three times a width W of the sub-pixel.

The opening width W of the V-shaped recessed portion is less than or equal to half of the width of the sub-pixel. For example, if the width of the sub-pixel is Wp, then W≤½Wp. At least one V-shaped groove recessed portion extending in the first direction is provided in the length direction of each sub-pixel.

As shown in FIG. 6D, a spacing Pv between adjacent V-shaped groove recessed portions meets W≤Pv≤Lp, where Lp represents a length of the pixel unit in the second direction Y. In some specific embodiments, Pv≤⅓Lp, that is, three V-shaped groove recessed portions extending in the first direction X may be provided in the length direction of a pixel unit.

FIG. 6E shows a curve of a peak light output brightness at the light guide plate lower end surface 41B changing with the spacing Pv between the V-shaped groove recessed portions. As the spacing increases from 0 μm to 150 μm, the peak light output brightness at the light guide plate lower end surface 41B first shows a small increase and gradually decreases at the spacing of 50 μm. That is, the spacing Pv between adjacent V-shaped groove recessed portions needs to be less than 50 μm to ensure a good peak light output brightness.

FIG. 6F shows a curve of a peak light output brightness at the light guide plate lower end surface changing the depth of the V-shaped groove recessed portion. As the depth h3 of the V-shaped groove recessed portion increases, the peak light output brightness at the light guide plate lower end surface 41B first gradually increases, and then remains unchanged when h3 is 5 μm. That is, when the depth h3 of the V-shaped groove recessed portion is greater than or equal to 5 μm, the peak light output brightness at the light guide plate lower end surface may be maintained at a large value.

FIG. 7A shows a schematic structural diagram of a light source of the light emitting assembly according to an exemplary embodiment of the present disclosure. FIG. 7B shows a schematic structural diagram of a light source of the light emitting assembly according to another exemplary embodiment of the present disclosure.

As shown in FIG. 7A, the light source 42 includes a single-row light source 42A formed by a plurality of illuminators spaced apart along the light guide plate peripheral side surface. For example, the illuminators may be LED lights.

A spacing G is formed between adjacent illuminators of the single-row light source 42A, and the spacing G meets the following relationship.

$$G = 2 \times A \times tan {θ}_{4}$$

where A represents a width from the light guide plate peripheral side surface 41C to the first region A1, and θ₄ represents a refractive angle of a light beam of the illuminator after entering the light guide plate 41.

Exemplarily, due to narrow bezel requirements of the display device, A is less than or equal to 5 mm. Through the above equation, it may be calculated that G is less than or equal to 0.35 mm. Since the single-row light source is formed by a plurality of illuminators spaced apart, in order to avoid the occurrence of strip-shaped light beams, the spacing G between the plurality of illuminators is reduced to achieve the above effect. While reducing the spacing G between the illuminators, the second recessed portions are provided in the second region of the light guide plate upper end surface 41A to further avoid the occurrence of strip-shaped light beams.

In another embodiment of the present disclosure, as shown in FIG. 7B, the light source includes a multi-row light source 42B formed by a plurality of single-row light sources staggered along the light guide plate peripheral side surface. For example, the light source may be formed by two single-row light sources staggered from each other. The single-row light source is formed by a plurality of illuminators spaced apart along the light guide plate peripheral side surface, and the illuminators of the plurality of single-row light sources are staggered, so that the light rays emitted by the illuminators of one single-row light source may be incident onto the light guide plate from a gap between the illuminators of the other single-row light source, thereby eliminating the stripe-shaped light beams.

In such embodiments, a spacing G is formed between adjacent illuminators of each single-row light source of the multi-row light source 42B, and 0.35 mm≤G≤0.9 mm. The use of multi-row light source may better avoid stripe-shaped light beams than a single-row light source, and the use of multi-row light source may result in a wider bezel of the display device than a single-row light source.

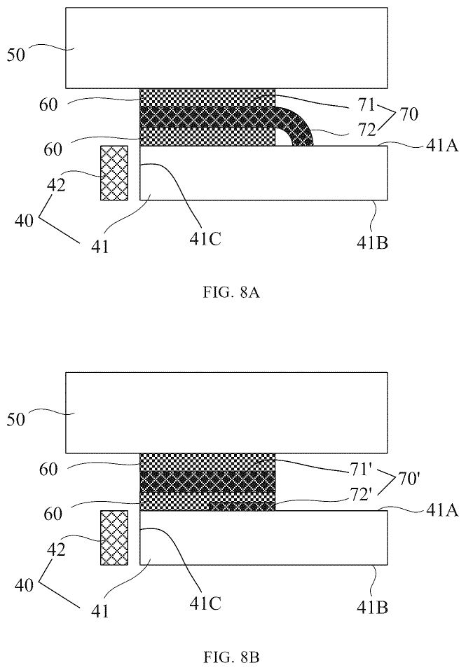

FIG. 8A shows a schematic structural diagram of a light shielding assembly of a display device according to an exemplary embodiment of the present disclosure. FIG. 8B shows a schematic structural diagram of a light shielding assembly of the display device according to another exemplary embodiment of the present disclosure.

In some embodiments of the present disclosure, the display device further includes a light shielding assembly 70 between the touch assembly 50 and the light emitting assembly 40, and an orthographic projection of the light shielding assembly 70 on the base substrate 10 falls within an orthographic projection of the second region A2 on the base substrate 10.

In some embodiments of the present disclosure, the display device further includes a bonding layer between the touch assembly 50 and the light shielding assembly 40 and between the light shielding assembly 40 and the light emitting assembly 70. An orthographic projection of the bonding layer on the base substrate falls within the orthographic projection of the second region on the base substrate. The bonding layer may be, for example, an OCA adhesive.

Exemplarily, when the touch assembly 50 and the light emitting assembly 40 are bonded using an edge lamination process, the OCA adhesive 60 between the light emitting assembly 40 and the touch assembly 50 may refract the light ray generated by the light emitting assembly, and a bright line on a side of the light emitting assembly close to the light source may be viewed at a large viewing angle. In order to avoid the appearance of the bright line, the light shielding assembly 70 is provided between the light emitting assembly 40 and the touch assembly 50 to improve the display effect of the display device under a large viewing angle.

As shown in FIG. 8A, in an embodiment, the light shielding assembly 70 includes: a shielding plate 71 parallel to the light guide plate upper end surface; and a bending portion 72 connected to the shielding plate, where the bending portion 72 is bent from the shielding plate 71 towards the light guide plate upper end surface 41A in a direction away from the light guide plate peripheral side surface 41C. The bending portion 72 may prevent light rays from exiting from a side edge of the OCA adhesive, thereby eliminating the bright line of the display device at a large viewing angle.

As shown in FIG. 8B, in another embodiment, a light shielding assembly 70′ includes: a shielding plate 71′ parallel to the light guide plate upper end surface; and a shielding sub-plate 72′ between the shielding plate and the light guide plate. An orthographic projection of the shielding sub-plate 72′ on the base substrate 10 falls within an orthographic projection of the shielding plate 71′ on the base substrate 10, and the shielding sub-plate 72′ is located close to the first region A1. The shielding sub-plate 72′ may prevent light rays from exiting from a side edge of the OCA adhesive, thereby eliminating the bright line of the display device at a large viewing angle.

In some embodiments of the present disclosure, when a full lamination process is adopted for the light emitting assembly and the touch assembly, a bonding layer is provided between the touch assembly and the light emitting assembly to bond the touch assembly and the light emitting assembly together. The bonding layer may be, for example, an OCA adhesive 60. Since the OCA adhesive has a significant refractive index difference from the light guide plate and the first recessed portion is provided on the light guide plate upper end surface, the light ray emitted by the light source may undergo total reflection after entering the light guide plate, and is finally transmitted downward and emitted from the light guide plate lower end surface.

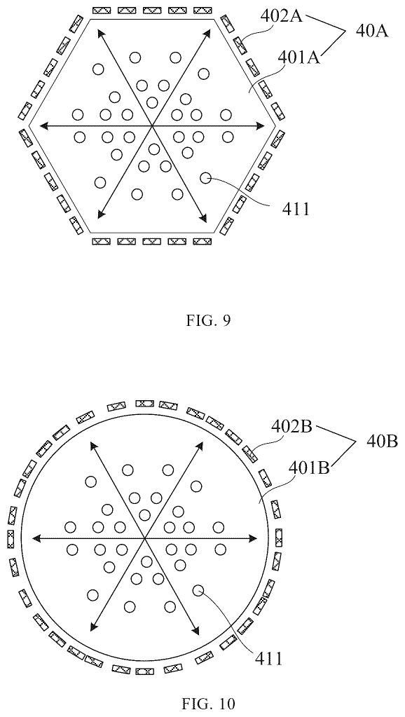

FIG. 9 shows a schematic diagram of a planar structure of a display device according to an exemplary embodiment of the present disclosure.

As shown in FIG. 9, the light guide plate of the light emitting assembly 40A adopts a polygonal structure, and an orthographic projection of the light guide plate on the base substrate is an n-sided polygon, such as a regular hexagon. The light guide plate 401A includes six peripheral side surfaces, and each peripheral side surface is provided with a light source 402A. A plurality of first recessed portions 411 are arranged in the first region of the light guide plate upper end surface. The distribution density ρ of the first recessed portions 411 in the first region gradually increases in a direction from a position close to the light guide plate peripheral side surface to a position away from the light guide plate peripheral side surface, that is, the distribution density of the first recessed portions 411 gradually decreases in an arrow direction. In other words, the distribution density of the first recessed portions gradually increases from the peripheral side surfaces to a center position of the regular hexagon.

Exemplarily, a plurality of second recessed portions are provided in the second region of the light guide plate upper end surface of the hexagonal light guide plate, and a plurality of third recessed portions are provided on the light guide plate lower end surface. The first recessed portion may be, for example, an n-sided pyramid-shaped recessed portion, an n-sided frustum-shaped recessed portion, a conical recessed portion, or a circular frustum-shaped recessed portion.

FIG. 10 shows a schematic diagram of a planar structure of a display device according to an exemplary embodiment of the present disclosure.

As shown in FIG. 10, the light guide plate of the light emitting assembly 40B adopts a circular structure, and an orthographic projection of the light guide plate 401B on the base substrate is a circle. The light guide plate 401B includes a circular peripheral side surface, and a light source 402B is provided around the light guide plate peripheral side surface. A plurality of first recessed portions 411 are arranged in the first region of the light guide plate upper end surface, and the distribution density ρ of the first recessed portions 411 in the first region gradually increases in a direction from a position close to the light guide plate peripheral side surface to a position away from the light guide plate peripheral side surface, that is, the distribution density of the first recessed portions gradually increases from an edge position of the circle to a center position of the circle. In other words, the distribution density of the first recessed portions 411 gradually decreases in an arrow direction.

Exemplarily, a plurality of second recessed portions are provided in the second region of the light guide plate upper end surface of the regular hexagonal light guide plate, and a plurality of third recessed portions are provided on the light guide plate lower end surface. The first recessed portion may be, for example, a conical recessed portion or a circular frustum-shaped recessed portion.

The display device may include any apparatus or product having a display function. For example, the display device may be a smart phone, a mobile phone, an e-book reader, a desktop personal computer (PC), a laptop PC, a netbook PC, a personal digital assistant (PDA), a portable multimedia player (PMP), a digital audio player, a mobile medical apparatus, a camera, a wearable apparatus (such as a head-mounted apparatus, electronic clothing, electronic bracelet, electronic necklace, electronic accessory, electronic tattoo, or smart watch), a television, etc.

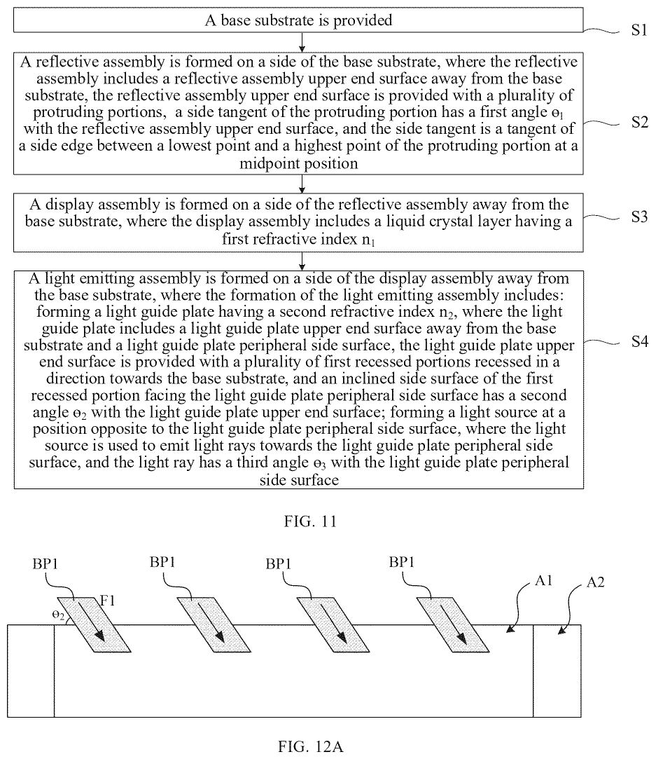

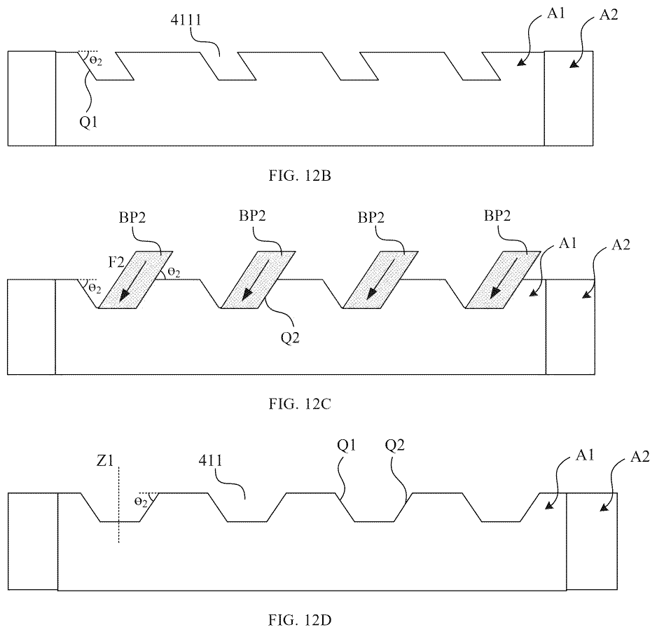

FIG. 11 shows a flowchart of a method of manufacturing a display device according to an exemplary embodiment of the present disclosure. FIG. 12A to FIG. 12D show schematic diagrams of a manufacturing process of the first recessed portion of the display device according to an exemplary embodiment of the present disclosure.

In another aspect of the present disclosure, a method of manufacturing a display device is provided. As shown in FIG. 11, the method of manufacturing the display device includes operation S1 to operation S4.

In operation S1, a base substrate is provided.

In operation S2, a reflective assembly is formed on a side of the base substrate, where the reflective assembly includes a reflective assembly upper end surface away from the base substrate, the reflective assembly upper end surface is provided with a plurality of protruding portions, a side tangent of the protruding portion has a first angle θ₁ with the reflective assembly upper end surface, and the side tangent is a tangent of a side edge between a lowest point and a highest point of the protruding portion at a midpoint position.

In operation S3, a display assembly is formed on a side of the reflective assembly away from the base substrate, where the display assembly includes a liquid crystal layer having a first refractive index n₁.

In operation S4, a light emitting assembly is formed on a side of the display assembly away from the base substrate. The formation of the light emitting assembly includes: forming a light guide plate having a second refractive index n₂, where the light guide plate includes a light guide plate upper end surface away from the base substrate and a light guide plate peripheral side surface, the light guide plate upper end surface is provided with a plurality of first recessed portions recessed in a direction towards the base substrate, and an inclined side surface of the first recessed portion facing the light guide plate peripheral side surface has a second angle θ₂ with the light guide plate upper end surface; forming a light source at a position opposite to the light guide plate peripheral side surface, where the light source is used to emit light rays towards the light guide plate peripheral side surface, and the light ray has a third angle θ₃ with the light guide plate peripheral side surface.

The second angle θ₂ meets the following relationship.

$${⊖}_{2} = 90 ° - \frac{1}{2} [ arccos ( \frac{1}{{n}_{2}} \times sin {θ}_{3} ) + arc sin ( \frac{{n}_{1}}{{n}_{2}} \times sin 2 {⊖}_{1} ) ] .$$

Exemplarily, the formation of the light guide plate includes: forming a first region of the light guide plate upper end surface so that an orthographic projection of the first region on the base substrate overlaps partially with an orthographic projection of the liquid crystal layer of the display assembly on the base substrate; and forming a second region of the light guide plate upper end surface so that the second region is located between the first region and the light guide plate peripheral side surface; forming the first recessed portion in the first region through a first ion beam etching process, forming a second recessed portion in the second region, and forming a third recessed portion on the light guide plate lower end surface through a second ion beam etching process.

For example, a light guide plate is provided, a first recessed portion is formed in a first region of the light guide plate through a first ion beam etching process, and a second recessed portion is formed in the second region. An ion beam in the first ion beam etching process used to form the first recessed portion may form a particular angle with the light guide plate upper end surface, and the angle is equal to the second angle θ₂.

The ion beam in the first ion beam etching process used to form the second recessed portion is perpendicular to the light guide plate upper end surface.

As shown in FIG. 12A to FIG. 12D, the first ion beam includes an inclined ion beam in a first direction F1 and an inclined ion beam in a second direction F2. Each first recessed portion has a symmetry axis Z1, and the inclined surfaces of the first recessed portion include a first inclined surface Q1 and a second inclined surface Q2 that are mirror symmetric with respect to the symmetry axis Z1.

The formation of the first recessed portion in the first region through the first ion beam etching process includes: etching to form the first inclined surface Q1 of the first recessed portion by an inclined ion beam in the first direction F1, and etching to form the second inclined surface Q2 of the first recessed portion by an inclined ion beam in the second direction F2. The first direction F1 and the second direction F2 are mirror symmetric with respect to the symmetry axis Z1. The first direction F1 forms a first angle θ₂₁ with the light guide plate upper end surface, and the second direction F2 forms a second angle θ22 with the light guide plate upper end surface, θ₂₁=θ₂₂=θ₂.

For example, as shown in FIG. 12A, the first region of the light guide plate upper end surface is etched by a first inclined ion beam BP1, and the inclined ion beam BP1 in the first direction F1 has an angel θ₂₁ with the light guide plate upper end surface. As shown in FIG. 12B, after the first etching is completed, a portion 4110 of the first recessed portion is formed, which includes the first inclined surface Q1 of the first recessed portion, and the inclined surface facing a light guide plate peripheral side surface forms a second angle θ₂ with the light guide plate upper end surface. As shown in FIG. 12C, an inclined ion beam BP2 in the second direction F2 is used to etch other portions of the first recessed portion, so as to form, for example, the second inclined surface of the first recessed portion facing another light guide plate peripheral side surface. The inclined ion beam BP2 in the second direction has an angle θ₂₂ with the light guide plate upper end surface. As shown in FIG. 12D, after the etching of the second inclined surface Q2 of the first recessed portion is completed, the first recessed portion 411 is formed, and each inclined side surface of the first recessed portion 411 facing the light guide plate peripheral side surface has a second angle θ₂ with the light guide plate upper end surface.

In some optional embodiments, when the first recessed portion has a plurality of (e.g., four or more) inclined surfaces, the first recessed portion may be etched using a plurality of first inclined ion beams, so that each inclined surface of the first recessed portion facing the light guide plate peripheral side surface has a second angle θ₂ with the light guide plate upper end surface.

It is possible to etch the second region to form the second recessed portion through an ion beam perpendicular to the light guide plate upper end surface simultaneously with the formation of the first recessed portion. Alternatively, the second recessed portion may be formed after the formation of the first recessed portion. After the first recessed portion and the second recessed portion are formed, a third recessed portion may be formed on the light guide plate lower end surface through a second ion beam etching process, then the manufacturing of the light guide plate is completed.

In the embodiments of the present disclosure, the process of forming the third recessed portion is similar to the process of forming the first recessed portion. Exemplarily, the second ion beam includes an inclined ion beam in a third direction and an inclined ion beam in a fourth direction. The third recessed portion has a symmetry plane, and the third recessed portion includes a first inclined surface and a second inclined surface that are mirror symmetrical with respect to the symmetry plane. For example, a V-shaped groove recessed portion is formed by the first inclined surface and the second inclined surface. The formation of the third recessed portion on the light guide plate lower end surface through a second ion beam etching process includes: etching to form the first inclined surface of the third recessed portion through an inclined ion beam in the third direction, and etching to form the second inclined surface of the third recessed portion through an inclined ion beam in the fourth direction. The third direction and the fourth direction are mirror symmetric with respect to the symmetry plane.

Herein, the terms “substantially”, “about”, “approximately, “roughly” and other similar terms are used as terms of approximation rather than terms of degree, and they are intended to explain an inherent deviation of a measured or calculated value that will be recognized by those ordinary skilled in the art. Taking into account a process fluctuation, a measurement problem, an error related to a measurement of a specific quantity (that is, a limitation of a measurement system) and other factors, the terms “about” or “approximately” used herein includes a stated value and means that a specific value determined by those ordinary skilled in the art is within an acceptable range of deviation. For example, “about” may mean being within one or more standard deviations, or within ±30%, ±20%, ±10% or ±5% of the stated value.

Some embodiments of the general technical concepts of the present disclosure have been shown and described. However, those skilled in the art may be understand that changes may be made to those embodiments without departing from the principles and spirit of the general technical concepts. The scope of the present disclosure is defined by the appended claims and their equivalents.

1. A display device, comprising:
a base substrate;
a reflective assembly on a side of the base substrate, wherein the reflective assembly comprises a reflective assembly upper end surface away from the base substrate, the reflective assembly upper end surface is provided with a plurality of protruding portions, a side tangent of the protruding portion has a first angle θ₁ with the reflective assembly upper end surface, and the side tangent is a tangent of a side edge between a lowest point and a highest point of the protruding portion at a midpoint position;
a display assembly on a side of the reflective assembly away from the base substrate, wherein the display assembly comprises a liquid crystal layer having a first refractive index n₁; and
a light emitting assembly on a side of the display assembly away from the base substrate, wherein the light emitting assembly comprises:
a light guide plate having a second refractive index n₂, wherein the light guide plate comprises a light guide plate upper end surface away from the base substrate and a light guide plate peripheral side surface, the light guide plate upper end surface is provided with a plurality of first recessed portions recessed in a direction towards the base substrate, and an inclined side surface of the first recessed portion facing the light guide plate peripheral side surface has a second angle θ₂ with the light guide plate upper end surface; and
a light source opposite to the light guide plate peripheral side surface, wherein the light source is configured to emit a light ray towards the light guide plate peripheral side surface, and the light ray has a third angle θ₃ with the light guide plate peripheral side surface,
wherein the second angle θ₂ meets a relationship of:
$${⊖}_{2} = {90}^{o} - \frac{1}{2} [ arccos ( \frac{1}{{n}_{2}} \times sin {θ}_{3} ) + arc sin ( \frac{{n}_{1}}{{n}_{2}} \times sin 2 {⊖}_{1} ) ] .$$

2. The display device according to claim 1, wherein the light guide plate upper end surface of the light guide plate comprises:
a first region, wherein an orthographic projection of the first region on the base substrate overlaps partially with an orthographic projection of the liquid crystal layer of the display assembly on the base substrate; and
a second region between the first region and the light guide plate peripheral side surface,
wherein the plurality of first recessed portions are arranged in the first region.

3. The display device according to claim 2, wherein a distribution density ρ of the plurality of first recessed portions in the first region gradually increases in a direction from a position close to the light guide plate peripheral side surface to a position away from the light guide plate peripheral side surface.

4. The display device according to claim 3, wherein the distribution density ρ of the plurality of first recessed portions in the first region meets a relationship of:
$$ρ = \frac{N \times {S}_{1}}{{S}_{2}}$$
where S₁ represents an opening area of the first recessed portion, S₂ represents a unit area, N represents the number of first recessed portions in the unit area S₂, and 4%≤ρ≤10%.

5. The display device according to claim 4, wherein an orthographic projection of the light guide plate on the base substrate is a circle; and
wherein the first recessed portion comprises a conical recessed portion or a circular frustum-shaped recessed portion, and a generatrix of the conical recessed portion or the circular frustum-shaped recessed portion has the second angle θ₂ with the light guide plate upper end surface.

6. The display device according to claim 5, wherein the orthographic projection of the light guide plate on the base substrate is an n-sided polygon, and n is an integer greater than or equal to 5; and
wherein the first recessed portion comprises:
a conical recessed portion or a circular frustum-shaped recessed portion, wherein a generatrix of the conical recessed portion or the circular frustum-shaped recessed portion has the second angle θ₂ with the light guide plate upper end surface; and/or
an n-sided pyramid-shaped recessed portion or an n-sided frustum-shaped recessed portion, wherein an inclined side surface of the n-sided pyramid-shaped recessed portion or the n-sided frustum-shaped recessed portion facing the light guide plate peripheral side surface has the second angle θ₂ with the light guide plate upper end surface.

7. The display device according to claim 4, wherein the orthographic projection of the light guide plate on the base substrate is a quadrilateral;
wherein the light guide plate peripheral side surface comprises a first peripheral side surface and a second peripheral side surface opposite to each other and a third peripheral side surface and a fourth peripheral side surface opposite to each other, and the third peripheral side surface and the fourth peripheral side surface each are connected and perpendicular to the first peripheral side surface and the second peripheral side surface; and
wherein the light source is opposite to the first peripheral side surface and the second peripheral side surface respectively.

8. The display device according to claim 7, wherein the first recessed portion comprises a quadrangular pyramid-shaped recessed portion, and the quadrangular pyramid-shaped recessed portion comprises:
a first inclined side surface facing the first peripheral side surface;
a second inclined side surface opposite to the first inclined side surface and facing the second peripheral side surface;
a third inclined side surface between the first inclined side surface and the second inclined side surface, wherein the third inclined side surface faces the third peripheral side surface; and
a fourth inclined side surface opposite to the third inclined side surface and facing the fourth peripheral side surface, wherein the first inclined side surface and the second inclined side surface respectively form the second angle θ₂ with the light guide plate upper end surface.

9. The display device according to claim 8, wherein the third inclined side surface and the fourth inclined side surface respectively form a fourth angle θ₄ with the light guide plate upper end surface, the second angle θ₂ is less than the fourth angle θ₄, and the fourth angle θ₄ is less than or equal to 80°.

10. The display device according to claim 9, wherein a connecting chamfer R is formed between inclined side surfaces of the quadrangular pyramid-shaped recessed portion, and the connecting chamfer R is less than or equal to 1.5 μm.

11. The display device according to claim 9, wherein the quadrangular pyramid-shaped recessed portion has a depth h1 recessed in a direction towards the base substrate, and 3 μm≤h1≤8 μm.

12. The display device according to claim 4, wherein a plurality of second recessed portions recessed in the direction towards the base substrate are uniformly provided in the second region of the light guide plate upper end surface, and the second recessed portion comprises a spherical crown-shaped recessed portion;
wherein the spherical crown-shaped recessed portion has a depth h2 recessed in the direction towards the base substrate, 1 m≤h2≤9 μm;
wherein the spherical crown-shaped recessed portion has a cross-sectional diameter D, 18 μm≤D≤50 μm; and
wherein a distribution density value of spherical crown-shaped recessed portions in the second region is less than or equal to 2%.

13. (canceled)

14. The display device according to claim 1, wherein the liquid crystal layer of the display assembly comprises a plurality of pixel units arranged in an array in a first direction and a second direction intersecting with the first direction, each pixel unit comprises a plurality of sub-pixels arranged sequentially in the first direction, and each sub-pixel has a length direction extending in the second direction and a width direction parallel to the first direction;
wherein the light guide plate comprises a light guide plate lower end surface close to the base substrate, the light guide plate lower end surface is provided with third recessed portions recessed in a direction away from the base substrate, and the third recessed portions comprise V-shaped groove recessed portions extending in the first direction and spaced apart in the second direction,
wherein the V-shaped groove recessed portion has a depth h3 in a direction away from the base substrate, 1 μm≤h3≤30 μm;
wherein the V-shaped groove recessed portion has an opening width W in the second direction, 5 μm≤W≤30 μm;
wherein the opening width of the V-shaped groove recessed portion is less than or equal to half of a width of the sub-pixel; and
wherein at least one V-shaped groove recessed portion extending in the first direction is provided in the length direction of each sub-pixel.

15-17. (canceled)

18. The display device according to claim 2, wherein:
the light source comprises a single-row light source formed by a plurality of illuminators spaced apart along the light guide plate peripheral side surface, a spacing G is formed between adjacent illuminators of the single-row light source, and the spacing G meets a relationship of:
$$G = 2 \times A \times tan {θ}_{4}$$
where A represents a width from the light guide plate peripheral side surface to the first region, and θ₄ represents a refractive angle of a light beam of the illuminator formed after the light beam enters the light guide plate, or
wherein the light source comprises a multi-row light source formed by a plurality of single-row light sources staggered along the light guide plate peripheral side surface, the single-row light source is formed by a plurality of illuminators spaced apart along the light guide plate peripheral side surface, a spacing G is formed between adjacent illuminators of the single-row light source, and 0.35 mm≤G≤0.9 mm.

19. (canceled)

20. The display device according to claim 2, further comprising:
a touch assembly on a side of the light emitting assembly away from the base substrate; and
a light shielding assembly between the touch assembly and the light emitting assembly, wherein an orthographic projection of the light shielding assembly on the base substrate falls within an orthographic projection of the second region on the base substrate.

21. The display device according to claim 20, wherein;
the light shielding assembly comprises:
a shielding plate parallel to the light guide plate upper end surface; and
a bending portion connected to the shielding plate, wherein the bending portion is bent from the shielding plate towards the light guide plate upper end surface in a direction away from the light guide plate peripheral side surface, or
the light shielding assembly comprises:
a shielding plate parallel to the light guide plate upper end surface; and
a shielding sub-plate between the shielding plate and the light guide plate, wherein an orthographic projection of the shielding sub-plate on the base substrate falls within an orthographic projection of the shielding plate on the base substrate, and the shielding sub-plate is close to the first region.

22. (canceled)

23. The display device according to claim 20, further comprising:
a bonding layer between the touch assembly and the light shielding assembly and between the light shielding assembly and the light emitting assembly, wherein an orthographic projection of the bonding layer on the base substrate falls within an orthographic projection of the second region on the base substrate.

24. The display device according to claim 2, further comprising:
a touch assembly on a side of the light emitting assembly away from the base substrate; and
a bonding layer between the touch assembly and the light emitting assembly, wherein the bonding layer is configured to bond the touch assembly with the light emitting assembly, and an orthographic projection of the bonding layer on the base substrate falls within the orthographic projection of the first region on the base substrate,
wherein the first angle θ1 is in a range of 5°≤θ1≤15°, and the second angle θ2 is in a range of 35°≤θ2≤50°.

25. (canceled)

26. A method of manufacturing a display device, comprising:
providing a base substrate;
forming a reflective assembly on a side of the base substrate, wherein the reflective assembly comprises a reflective assembly upper end surface away from the base substrate, the reflective assembly upper end surface is provided with a plurality of protruding portions, a side tangent of the protruding portion has a first angle θ₁ with the reflective assembly upper end surface, and the side tangent is a tangent of a side edge between a lowest point and a highest point of the protruding portion at a midpoint position;
forming a display assembly on a side of the reflective assembly away from the base substrate, wherein the display assembly comprises a liquid crystal layer having a first refractive index n₁;
forming a light emitting assembly on a side of the display assembly away from the base substrate, wherein the forming a light emitting assembly comprises:
forming a light guide plate having a second refractive index n₂, wherein the light guide plate comprises a light guide plate upper end surface away from the base substrate and a light guide plate peripheral side surface, the light guide plate upper end surface is provided with a plurality of first recessed portions recessed in a direction towards the base substrate, and an inclined side surface of the first recessed portion facing the light guide plate peripheral side surface has a second angle θ₂ with the light guide plate upper end surface; and
forming a light source at a position opposite to the light guide plate peripheral side surface, wherein the light source is configured to emit a light ray towards the light guide plate peripheral side surface, and the light ray has a third angle θ₃ with the light guide plate peripheral side surface,
wherein the second angle θ₂ meets a relationship of:
$${⊖}_{2} = {90}^{o} - \frac{1}{2} [ arccos ( \frac{1}{{n}_{2}} \times sin {θ}_{3} ) + arc sin ( \frac{{n}_{1}}{{n}_{2}} \times sin 2 {⊖}_{1} ) ] .$$

27. The method according to claim 26, wherein the forming a light guide plate comprises:
forming a first region of the light guide plate upper end surface so that an orthographic projection of the first region on the base substrate overlaps partially with an orthographic projection of the liquid crystal layer of the display assembly on the base substrate, and forming a second region of the light guide plate upper end surface so that the second region is located between the first region and the light guide plate peripheral side surface;
forming the first recessed portion in the first region and a second recessed portion in the second region through a first ion beam etching process; and
forming a third recessed portion on a light guide plate lower end surface through a second ion beam etching process;
wherein a first ion beam comprises an inclined ion beam in a first direction and an inclined ion beam in a second direction, the first recessed portion has a symmetry axis, and an inclined surface of the first recessed portion comprises a first inclined surface and a second inclined surface that are mirror symmetric with respect to the symmetry axis, and the forming the first recessed portion in the first region through a first ion beam etching process comprises:
etching to form the first inclined surface of the first recessed portion through the inclined ion beam in the first direction, and etching to form the second inclined surface of the first recessed portion through the inclined ion beam in the second direction, wherein the first direction and the second direction are mirror symmetric with respect to the symmetry axis, the first direction has a first angle θ21 with the light guide plate upper end surface, the second direction has a second angle θ22 with the light guide plate upper end surface, and θ21=θ22=θ2, and
wherein the second ion beam comprises an inclined ion beam in a third direction and an inclined ion beam in a fourth direction, the third recessed portion has a symmetry plane, the third recessed portion comprises a first inclined surface and a second inclined surface that are mirror symmetric with respect to the symmetry plane, and the forming a third recessed portion on the light guide plate lower end surface through a second ion beam etching process comprises:
etching to form the first inclined surface of the third recessed portion through the inclined ion beam in the third direction, and etching to form the second inclined surface of the third recessed portion through the inclined ion beam in the fourth direction, wherein the third direction and the fourth direction are mirror symmetric with respect to the symmetry plane.

28-29. (canceled)
